(19) United States
(12) Patent Application Publication
(10) Pub. No.: US 2002/0026429 A1
(43) Pub. Date: Feb. 28, 2002

(54) Transactional method and system for semi-fungible commodity items

(76) Inventors: Alain Lostis, Le Port Marly (FR); Ugo Capolino, Amsterdam (NL); Jan Siderius, Loenen a.d. Vecht (NL)

Correspondence Address: MORGAN & FINNEGAN, L.L.P., 345 Park Avenue, New York, NY, 10154-0053, US

(21) Appl. No.: 09/841,020

(22) Filed: Apr. 24, 2001

Related U.S. Application Data
(63) Continuation-in-part of application No. 09/573,828, filed on May 18, 2000.

(51) Int. Cl. G06F 17/60

(52) U.S. Cl. 705/80; 705/8

(57) ABSTRACT

A negotiation arrangement which allows an entity to allocate needs to at least one of at least two tendered semi-fungible category components, each having an associated value specified by its respective tenderor and an index representing a utility to the entity and allows a tenderor to modify the associated value following an allocation by the entity.

### CROSS REFERENCE TO RELATED APPLICATION(S)

This application is a continuation-in-part of co-pending U.S. patent application Ser. No. 09/573,828 filed May 18, 2000.

### FIELD OF THE INVENTION

The invention relates to on-line transactions and more particularly to on-line transactions involving semi-fungible commodity items, services or tender of rights.

### COPYRIGHT RIGHTS

A portion of the disclosure of this patent document contains material that is protected by copyright. The copyright owner has no objection to the facsimile reproduction of the patent document or the patent disclosure as it appears in the Patent and Trademark Office file or records, but otherwise reserves all copyright rights whatsoever. BACKGROUND OF THE INVENTION

Group purchasing organizations have been around for many years and leverage purchase price based upon the adage that there is “strength in numbers”. With group purchasing, multiple purchasers of small volumes of a given commodity item can pool their order with others to take advantage of volume discounts or negotiate for better prices than they could get. This is often done through a third party agent who acts, and often negotiates, on behalf of the group or who independently appends smaller orders onto the regular bulk purchases of a high volume client for a small fee.

By way of example, assume a supplier offers a commodity item at a quantity discount of 10% for each 100 units ordered per month, to a maximum of a 40% discount. A purchaser having a need for 25 units of a particular item per month ordering alone from the supplier would pay full price. However, by pooling with others such that collectively, they can order 120 units, the collective purchase would qualify for the discount all purchasers will receive their items for 10% less. Moreover, if the group can increase the order (through increasing their individual order size and/or the number of purchasers) to collectively 400+ units, they all will enjoy a 40% discount even if no single member of the group purchases more than 50 units. Depending upon the collective or aggregate volume, they may even be able to negotiate a better price for an incremental increase in volume.

Group purchase organizations can be very effective for multiple purchasers of specifically identified commodity items and/or wholly fungible commodity items. The former works well because all purchasers specifically desire the identical item. The latter works well when the nature of the item, a specific brand or style may be unimportant, for example, red ball-point pens, because the order can be filled generically from the supplier's existing stock. It also provides a way for suppliers to be more competitive since they can more easily dispose of, for example, discontinued items and/or odd lots of mixed brand items as at least part of the order.

Group purchase organizations however, require purchasers to give up some measure of control over the process so that the needs of all members of the group can be accommodated as a unit. Moreover, during negotiation most, if not all, purchasers do not have the ability to participate in the negotiation on an ongoing or dynamic basis and have no ability to allocate their purchase among multiple suppliers.

The human and animal healthcare and research fields, i.e. medical, dental, hospitals, nursing homes, rehabilitation centers, veterinary clinics, etc. (hereafter collectively referred to as “healthcare areas”), especially those related to human health, are particularly cost sensitive. This is due, in part in the case of human health, to insurance company oversight, Health Maintenance Organizations, Preferred Provider Organizations, increased competition and/or the amount of available funding. As a result, group purchasing organizations have specifically been used in healthcare areas to lower costs and/or stretch available funds.

Although certain items in the healthcare areas may be wholly fungible, such as sterile gauze pads, tongue depressions or cotton swabs, many others are not. One representative example of a non-fungible product category is polymorphic drugs since, although belonging to the same class or being of the same generic type, may differ in how they are metabolized, tolerated or in their effectivity. Those differences may be reflected in the cost of an individual item in the category and/or the needs of the purchaser. Similarly, certain items may be fungible specialty products only because they have equivalent utility. For example, a hospital may purchase blood bags which, depending upon the specific supplier, may have a slightly thicker wall thickness or a slightly different amount or formulation of anticoagulant. Although, as a practical matter, they are fungible for purposes of blood collection, in reality the hospital may have a preference for a particular wall thickness due to the type of handling the bags receive or a particular anticoagulant amount or formulation because of certain variations in storage environments.

As a result, those types of items, referred to herein as “semi-fungible” commodity items are not generally suitable for conventional group purchases at the product category level.

The same is true to a lesser extent in other fields of endeavor. By way of example, lighting fixtures can be used as a representative non-medical semi-fungible commodity item. Housing contractors may have need for different types of lighting fixtures for use in new home construction and all have equivalent utility-lighting. Yet there may be differences among fixtures within those types, for example, high hat lights with black, white and chrome rims or wall sconces in gold tone, matte black and brushed aluminum. A contractor may have an aggregate need for 110 sconces but differing needs within the category, for example, due to different available decors, but may not care who the manufacturers of the particular sconces are. To the extent a supplier treated a difference in finish or rim as a different item, an order of 110 sconces which might otherwise generically be subject to a 35% discount (because more than 100 units were purchased) they would be considered by the supplier to be 3 individual item orders of 60 gold tone, 30 matte black and 20 brushed aluminum units and hence subject to no discount. As in the healthcare areas, the problem is compounded when there is a difference in price based upon certain differences within the item class.

It has been proposed to perform group purchasing according to a “stock exchange” like model. However, a stock exchange model does not allow for dynamic allocation by the purchaser during negotiation, it merely allows purchasers to specify the price they are willing to pay and suppliers to specify their asking price. Suppliers lower their prices based upon the prices of others and no deal is set until the “trading day” ends at which time the lowest price wins.

Another problem present in the prior art is compliance. Compliance problems result because purchasers cede decision-making control and there are times when purchaser discontent with the results of the group purchase are unacceptable to that purchaser. As a result, that purchaser backs out or defaults.

Thus, the ability to take advantage of the benefits of group purchase without ceding purchase control to a third party agent is highly desirable. Additionally, it is a separate additional advantage to be able to achieve a high level of compliance in the process. The ability to leverage the power of group purchasing for non-fungible items within a product category is also separately and independently highly desirable.

In the case of tender of rights-type arrangements, entities may have rights they are willing to tender, for a fee, that are also semi-fungible. For example, an owner of several parking lots in a given area may wish to outsource management of the lots, by way of an auction type negotiation, based upon a combination of service, security, income from parking fees and/or other factors. Since the lots are different, the service requirements will be different. Moreover, for example for a more remote lot, the owner may be willing to accept lower income from fees if a higher level of security is provided. Alternatively, an owner may prefer to have valet parking in one lot and self-parking or some combination of valet and self-parking in another.

Thus, the ability to compare the semi-fungible service offers of different suppliers according to purchaser preferences is also highly desirable. Presently, to the extent such services are susceptible to group purchasing, those group purchase arrangements suffer similar problems to those of products, namely, differing needs, ceding control, etc.

Moreover, the ability to leverage a form of group purchasing power for tender of semi-fungible rights is also highly desirable.

### SUMMARY OF THE INVENTION

In general, in a first aspect, the invention features negotiation method involving: allowing an entity to allocate needs to at least one of at least two tendered semi-fungible category components, all of the at least two tendered components being either a product item, a service or a right, and each having an associated value specified by its respective tenderor and an index representing a utility to the entity; and allowing a tenderor to modify the associated value following an allocation by the entity.

In another aspect, the entity is one of at least two entities and the invention features allowing another of the at least two entities to allocate a needs award to at least one of at least two tendered semi-fungible category components.

In further aspects, the invention features one or more of providing for utility adjusted valuing, providing optimization prompting, providing value for money prompting, and/or providing maximization prompting.

These and other aspects described herein, or resulting from the using teachings contained herein, provide advantages and benefits over the prior art.

The advantages and features described herein are a few of the many advantages and features available from representative embodiments and are presented only to assist in understanding the invention. It should be understood that they are not to be considered limitations on the invention as defined by the claims, or limitations on equivalents to the claims. For instance, some of these advantages are mutually contradictory, in that they cannot be simultaneously present in a single embodiment. Similarly, some advantages are applicable to one aspect of the invention, and inapplicable to others. Thus, this summary of features and advantages should not be considered dispositive in determining equivalence. Additional features and advantages of the invention will become apparent in the following description, from the drawings, and from the claims.

### BRIEF DESCRIPTION OF THE DRAWINGS

FIG. 1 is an example system employing the principles of the invention;

FIG. 2 is an example purchaser screen;

FIG. 3 is an example alternative purchase screen;

FIG. 4 is an example advanced purchaser screen;

FIG. 5 is an example alternative advanced purchaser screen;

FIG. 6 is an example supplier bid screen;

FIG. 7 is an example alternative supplied bid screen;

FIG. 8 is an example preferred supplier bid screen;

FIG. 9 is an example alternative preferred supplier bid screen;

FIG. 10 is an example price utility function curve;

FIG. 11 is an example price-utility graph with a threshold;

FIG. 12 is an example illustration of the state of an example negotiation at a specified time employing a purchaser decision support tool;

FIG. 13 is the negotiation of FIG. 12 at a later time;

FIG. 14 is an example utility function band;

FIG. 15 is an example display from a supplier decision support tool;

FIG. 16 is another example display from a supplier decision support tool;

FIG. 17 is an example negotiation at a specified time employing a price utility band;

FIG. 18A is an example price vs. utility linear graph for values provided by example purchaser 1;

FIG. 18B is an example benchmark vs. utility graph for purchaser 1 having a slope scaled from FIG. 18A;

FIG. 19A is an example price vs. utility linear graph for values provided by example purchaser 2;

FIG. 19B is an example benchmark vs. utility graph for purchaser 2 having a slope scaled from FIG. 19A;

FIG. 20A is an example price vs. utility linear graph for values provided by example purchaser 3;

FIG. 20B is an example benchmark vs. utility graph for purchaser 3 having a slope scaled from FIG. 20A;

FIG. 21 is an example Request For Proposal (RFP) screen for a commercially suitable example system including some of the options described herein;

FIG. 22 is an example Preferences screen for the commercially suitable example system referred to in connection with FIG. 21;

FIG. 23 is an example Product Attributes screen for the commercially suitable example system referred to in connection with FIG. 21;

FIG. 24 is an example View Scores screen for the commercially suitable example system referred to in connection with FIG. 21;

FIG. 25 is an example Calibration screen for the commercially suitable example system referred to in connection with FIG. 21;

FIG. 26 is an example Allocation Strategy screen for the commercially suitable example system referred to in connection with FIG. 21;

FIG. 27 is an example Adjustment screen for the commercially suitable example system referred to in connection with FIG. 21 ;and

FIG. 28 is an example Negotiation screen for the commercially suitable example system referred to in connection with FIG. 21.

### DETAILED DESCRIPTION

The entire disclosure of U.S. patent application Ser. No. 09/573,828 filed May 18, 2000 is incorporated herein by reference.

### System Environment

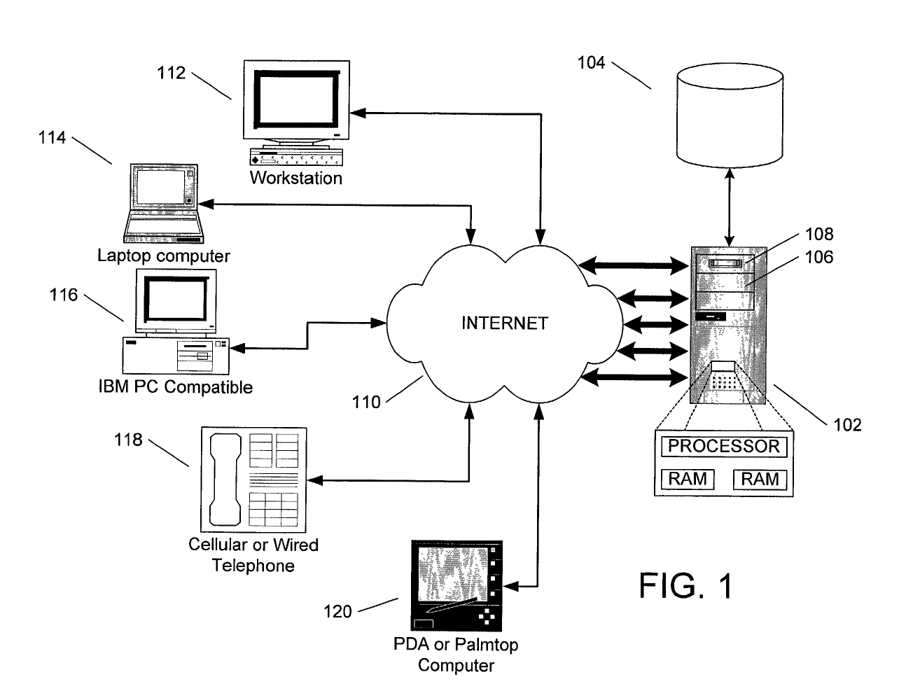

FIG. 1 shows one simple configuration employing the principles of the invention. In this configuration, a single computer 102 with its associated storage 104 serves as the focal point for the transactional events. The computer can be any computer, from a basic server through and including a mainframe computer. Such computers are available from numerous manufacturers and/or distributors such as IBM, Compaq, Sun, Unisys, Hewlett-Packard, Groupe Bull and Siemens. For commercial usage the chosen computer should be capable of supporting the requisite number of participants for one or more negotiations at a given time by running one or more programs written to operate according to the principles described herein. Typically, such a computer 102 will include one or more processors Random Access Memory (RAM), Read Only Memory (ROM), storage in the form of a disk drive 106, disk array and/or tape drive 108 and support multiple simultaneous I/O connections through which a negotiation can proceed.

Depending upon the particular arrangement, the I/O connections may take the form of website accessible via the internet 110, a direct dial-in connection, and/or an interface to allow for negotiation using a workstation 112, laptop computer 114, desktop computer 116, handheld device such as a cellular phone 118, personal digital assistant or palmtop computer 120 or the like. In most cases, the interface will be graphics based, due to the ubiquity of world available connections to the wide web and the prevalence of web browsers. However, in order to facilitate usage, support for non-graphical access such as touch-tone or voice recognition and generation capability may be employed in a straight forward manner although some features by their graphical nature may be unavailable to those users.

In alternative configurations, multiple computers and/or servers may be employed in a distributed fashion, for example, for scaling of overall capacity, load handling or to take advantage of parallel processing or multiprocessing technology. Additionally, auxiliary servers may be employed for purposes of security, monitoring, upgrade, development and debug, the use of such servers being well known and generally unimportant for purposes of understanding the invention as described herein.

### Participant Qualification

In order to be a participant, on either the supplier or purchaser side of a negotiation, the participant entity should be qualified so that reasonably foreseeable business problems related to, for example, lack of capacity or financial instability, are not encountered following conclusion of a negotiation. As a further protection for both purchasers and suppliers, each should ideally agree to be contractually be bound by the state of the negotiation at its conclusion. In fact, in some instances, it may be desirable to include in the agreement which binds the participants some express penalty for a participant who reneges. One advantage achievable in some embodiments resulting from the agreement to be bound coupled with each purchaser's ability to select one or more particular bidding supplier and allocate volumes is a significantly increased likelihood of 100% compliance.

Depending upon the particular semi-fungible commodity items that are subject to the negotiation, qualification may be as simple as requiring that a purchaser provide a credit card number with a sufficient credit limit which will be charged upon completion of the negotiation. In other cases, a letter of credit for the purchaser may be necessary. On the supplier side, suitable criteria may also be employed for qualification purposes which, in many instances, will be the same as would conventionally be used to validate a bidder responding to a request for proposal or request for quote in the particular context or industry.

Once qualified, and if required, agreeing to be bound, a purchaser and/or supplier is eligible to participate in an on-line negotiation session.

Of course, purchasers and/or suppliers can be further qualified on the basis of, for example, membership status, volumes purchased, number of times they have been a party to an on-line negotiation and/or other criteria which would allow them to receive certain additional benefits or access additional features unavailable to the ordinary qualified user.

Irrespective of the particular status or tier level a particular user may be qualified for, users are generally classifiable as either a purchaser or supplier for a given negotiation. Of course, depending upon the particular items being negotiated for, a purchaser for purposes of one negotiation may be a supplier for purposes of another and vice-versa. Moreover, depending upon the semi-fungible commodity items negotiated for, a complex negotiation can even result in a single entity being a purchaser and supplier for different items in the same negotiation, for example, where one of the items is used in the production of or is a subcomponent of another item.

### Purchaser/Supplier Knowledge of Each Other

One factor which can affect any negotiation is the knowledge the parties involved in the negotiation have about each other. In some cases, this knowledge can result in the parties negotiating a less favorable result than they would without the knowledge. As a result, the negotiation arrangement described herein can be implemented anywhere along the disclosure spectrum; from a fully blind negotiation, in which none of the suppliers or purchasers in a negotiation directly know who the others are at any stage of that negotiation, to a fully open negotiation in which all suppliers and purchasers in a particular negotiation know who each other is and the actions taken by each, or anywhere in-between.

In a fully blind negotiation, a third party acts as an intermediary so that none of the suppliers or purchasers can directly identify each other at any stage. In this arrangement, all billing and shipment is done via the third party who may charge a fee based upon, for example, the number of bidders, suppliers, drop points, or as a fixed percentage of invoice value, etc. Using this arrangement, the ultimate sales contract(s) between supplier and purchaser resulting from the negotiation may actually be made up of one or more supplier-third party contracts and one or more purchaser-third party contracts.

In other implementations a partially blind arrangement may take, for example, any of the following forms (or combinations thereof): a) one or more purchasers are identified to each other, but the suppliers are not directly identified to purchasers or each other; b) one or more suppliers are identified to each other, but not to one or more purchasers; c) purchasers and suppliers are not identified to each other until the negotiation time runs out, at which time, each supplier is provided with a breakdown of each purchaser's volume, shipment information, etc.; d) one purchaser is presented in the negotiation as two or more purchasers having differing semi-fungible commodity item requirements; or e) a supplier offering two or more different semi-fungible commodity items is presented as two different suppliers.

### Product Purchaser Interface

When a purchaser agrees to participate in the product negotiation they are given access to an aggregation server and are presented with an interface that will be used for that product negotiation. Depending upon the particular implementation, the interface may be accessed via the internet using a specific URL or Internet Protocol (IP) address, via a cable modem, DSL connection, through a separate dial-up connection, through a network connection, etc. and which may also incorporate some form(s) of security to prevent unauthorized access. Since, numerous computer security techniques are known, such as encryption, password protection, etc. it will be recognized that the use of security or any particular technique will depend upon the specific implementation.

When the purchaser connects, for example, through a direct dial-up connection to an aggregation server which, although not reached through the internet, supports a graphical interface such as one of the widely available web browsers or is accessed using a proprietary graphical interface, they are presented with a Purchaser Screen. The Purchaser Screen allows a purchaser to view, in real-time, the current status of the bidding for their requirements and their current allocation of their volume.

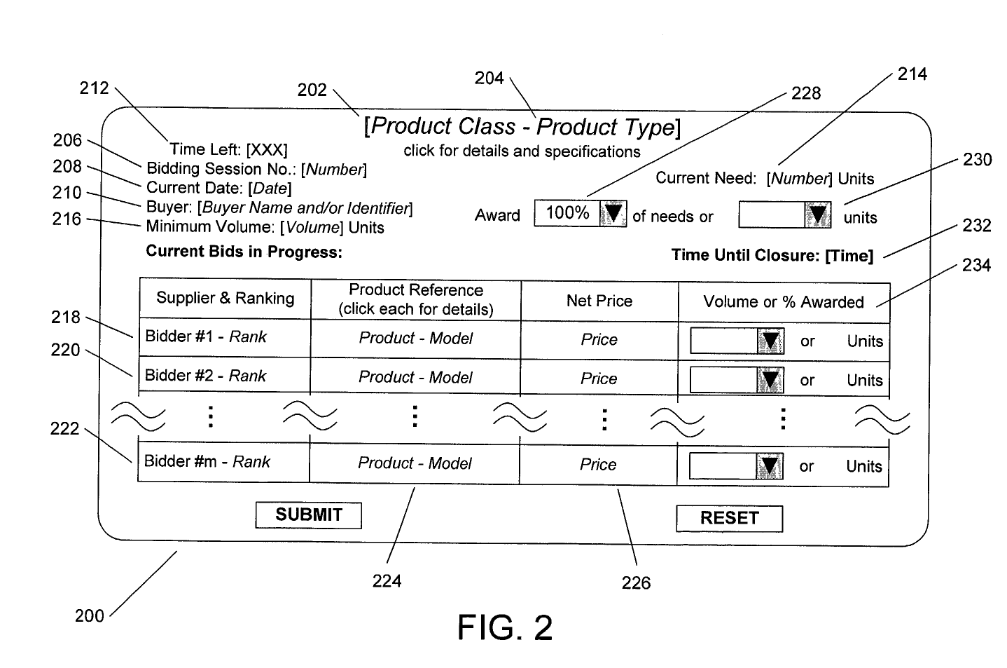

One commercially suitable example of a Purchaser Screen is shown in FIG. 2. The Purchaser Screen 200 in this example identifies the semi-fungible commodity item by class 202 and/or type 204 to be purchased. The Purchaser Screen 200 also identifies the bidding session 206 the current date 208, and a buyer identifier 210, by name and/or other identifier. Bidding is limited to a specified time period so, as will be described in greater detail below, a “Time Left” or Time Remaining counter 212 is provided. The bidding period is preferably kept short (a few hours or less) so that the dynamic aspect can be optimally utilized and, although it is not required, ideally all suppliers and purchasers should be connected for most, if not all, of the bidding period. Of course, in some implementations, certain factors or concerns may make it necessary or desirable to use longer bidding periods such as days or weeks. In those cases, it will be recognized that some advantages may be reduced or lost, even though the operation is fully consistent with the principles described herein.

A purchaser enters their current need 214 and, depending upon the implementation, a minimum allocation or award volume 216 is either calculated or is presented based upon some prior agreement. This minimum volume may be a percent of the current need, a minimum allocation increment, or simply a “floor” amount for an initial allocation to ensure to suppliers that if they receive any allocation, they will receive at least that amount. For example, if the Minimum Volume 216 was 100 units, a purchaser could allocate no less than 100 units to a supplier, but could allocate 110, 123, 247 units. Alternatively, the same Minimum Volume 216 could constrain allocations to allocations in 100 unit increments, i.e. 100, 200, 300, etc. units.

Once a negotiation begins, the current bids in progress are displayed for the purchaser. As shown in FIG. 2, this is done in tabular form such that each qualified bidding supplier 218, 220, 222 is identified to the purchaser along with the semi-fungible commodity item(s) being offered 224 and the net price 226 being bid. In the case of a fully or partially blind arrangement, each bidder may simply be identified, as shown, as “Bidder #1” 218, “Bidder #2” 220 or “Bidder #m” 222 or by some string of characters or numbers usable by the system to uniquely identify each bidder.

The purchaser then decides how much of their current needs they will be awarding. This can be done by simply allowing typing in the information or by using pull down menus for the percentage 228 of needs or volume 230. As will be apparent, by allowing the purchaser to allocate less than their total needs, the purchaser can make an overall allocation decision “on-the-fly” based upon, for example, the specific products being bid. This represents a marked improvement over the prior art because, under the appropriate circumstances, a purchaser can decide to divide their purchase among suppliers or not to award some portion (or even all) of their needs based upon factors other than lowest price as contrasted with the prior art where the volume communicated to the group purchasing organization is the volume which will almost certainly be awarded.

This has profound advantages in the healthcare areas for purchases of, for example, polymorphic drugs or drugs where there is a synthetic, animal derived or human derived version. In one example, if a given healthcare provider has needs for 1000 units of insulin and is willing to accept up to 400 units in animal derived insulin, if all suppliers only bid animal derived insulin, the purchaser can decide to only award a maximum of 400 units. Similarly, in areas other than healthcare, if a negotiation involves the material used to fix holes in walls sometimes called “patching compound” or “wallboard compound” and the purchaser does not want any acrylic-based compounds, if all suppliers bid acrylic-based compounds, that purchaser may opt not to award any of their needs.

Of course, since a negotiation typically will involve two or more purchasers, the volume suppliers will be bidding for is a portion (or all) of the aggregate of the amount each purchaser agrees to award, not the amount entered as their current need.

The purchaser interface allows a purchaser to see all currently pending bids from all suppliers displayed concurrently, typically one entry for each bidder and/or bid product. Purchasers can then allocate volume 234 by, for example, amount of units or percent of volume, to none, any or all bidders, subject to the minimum volume 216 constraint, if any.

When the suppliers enter their product and bid information for a given negotiation, each purchaser's “Current Bids in Progress” information is updated to show the current state of bidding. Similarly, if a bidder modifies a bid, the purchaser will see this change reflected on their display in real-time. This happens until the “Time Until Closure” 232.

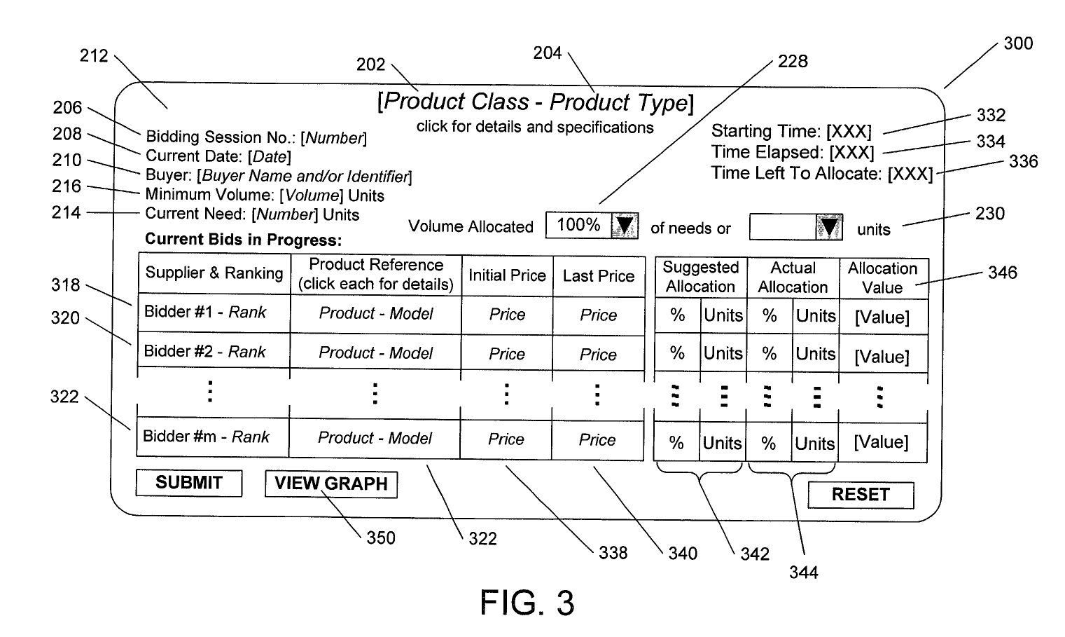

Another commercially suitable example of a Purchaser Screen is shown in FIG. 3. As with the Purchaser Screen 200 of FIG. 2, the Purchaser Screen 300 in this example identifies the semi-fungible commodity item by class 202 and/or type 204 to be purchased. The Purchaser Screen 300 also identifies the bidding session 206 the current date 208, and a buyer identifier 210, by name and/or other identifier. However, in this variant, bidding occurs during specific time periods so, as will be described in greater detail below, “Starting Time” 332, “Time Elapsed” 334, and “Time Left To Allocate” 336 indicators are used. The “Starting Time” 332 indicates the time the negotiation started or is to start. Thus, if the negotiation has not yet begun, this counter may be a negative number, in which case it identifies the time until the negotiation begins; it may be a zero, indicating that the negotiation has not begun; or it may be a specific time (and date) the negotiation will begin.

The “Time Elapsed” 334 indicator is used to identify the amount of time the negotiation has been in progress. Alternatively, this indicator can be augmented and/or replaced by a “Time To End” indicator (not shown) which would indicate when the negotiation will end, for example, if no criteria for ending the negotiation based upon activity (or lack thereof) was in place or, if available, was triggered.

The “Time Left To Allocate” 336 indicator indicates the remaining time in an allocation cycle. Depending upon the particular cycle arrangement used, this can also be used to indicate when a bidding cycle is occurring, for example, using a negative counter or displaying some non-numeric symbols.

The overall negotiation period is preferably kept short (a few hours or less) so that the dynamic aspect can be optimally utilized and, although it is not required, ideally all suppliers and purchasers should be connected for most, if not all, of the bidding period. Negotiations occur in “quasi real-time” using alternating bid and allocation periods. The system cycles back and forth between a bidding cycle and an allocation cycle. During a bidding cycle, suppliers may modify their offering prices and purchaser screens are frozen so that either no allocations may be made or changed during a bidding cycle, or allocations made or changed will be accepted but not processed until the next allocation cycle. Similarly, during an allocation cycle, purchasers may newly allocate or modify existing allocations to supplier products and suppliers either can not change prices, or price changes are accepted but not processed, until the next bidding cycle. At the end of a bidding cycle, purchaser visible information is updated to reflect any changes and pending purchaser actions are processed. Similarly, at the end of an allocation cycle, individual purchaser allocations are aggregated for each offered product, bidder visible information is updated to reflect those aggregations, and pending bidder actions are processed.

Depending upon the specific implementation, the duration of the cycles can be the same or can differ as between allocation and billing cycles. Typically, although not a requirement, each allocation cycle will be of the same duration, as will each bidding cycle. In the case where allocation cycle duration differs from bidding cycle duration, the difference can be specified by the system, agreed to by the participants, or based upon some factor such as, for example, the number of purchasers, the number of suppliers, some ratio relating to number of purchasers vs. suppliers, the number or type of different offered items, or the minimum volume allocation amounts, to name a few.

In any case, the cycle durations should typically be short, less than an hour, and typically on the order of 2 to 5 minutes each. Of course it will be apparent that as the cycle duration is shortened, a real-time negotiation is approached. Hence, a variant employing a cycle time option can be thought of as a “quasi-real-time” variant.

As with the actions described in connection with FIG. 2, a purchaser enters their current need 214 and, depending upon the implementation, a minimum allocation or award volume 216 is calculated or presented.

Once a product negotiation begins, the current bids in progress are displayed for the purchaser. As shown in FIG. 3, this is done in tabular form such that each qualified bidding supplier 318, 320, 322 is identified to the purchaser along with each of the semi-fungible commodity item(s) being offered 324.

The purchaser then initially decides how much of their current needs they will be awarding. This can be done, as with FIG. 2, by typing in the information or by using pull down menus.

Unlike FIG. 2, in this variant, the Purchaser Screen 300 includes an “Initial Price” 338, “Last Price” 340, “Suggested Allocation” 342, “Actual Allocation” 344, and “Allocation Value” 346.

The Purchaser Screen 300 allows a purchaser to see all currently pending bids from all suppliers displayed concurrently, typically one entry for each bidder and/or bid product. As described in connection with FIG. 2, purchasers allocate volume by, for example, amount of units or percent of volume, to none, any or all bidders, subject to the minimum volume 216 constraint, if any.

When the suppliers enter their product and bid information for a given negotiation, each purchaser's Current Bids in Progress information is updated to show the current state of bidding. Initially, the pending bids are displayed as the “Initial Price” 338. If a bidder modifies a bid, the purchaser will see this change reflected in the “Last Price” 340.

When the purchaser allocates volume to a specific semi-fungible item, that allocation is entered under “Actual Allocation” 344 as either a percent (%) or number of units. The “Allocation Value” 346 represents the product of the “Last Price” and “Actual Allocation” for each item.

Additionally, the system may also provide a “Suggested Allocation” 342 based upon some analysis done by the system. This analysis may involve an analysis of historical data and/or current actions, for example using artificial intelligence techniques, it may employ a simple analysis based upon, for example, the lowest price for an item meeting some purchaser specified criterion or criteria, or it may be derived by an application of multi-attribute utility theory techniques.

The “Suggested Allocation” 342 prompts the purchaser with information which allocation which allows them to make more economically efficient use of funds in allocating volumes by suggesting an allocation most closely fitting some purchaser specified requirements or preferences. The “Suggested Allocation” 342 also provides an analytical “second opinion” for the purchaser regarding their allocations. For example, purchaser actual allocations matching the suggested allocations indicate that the purchaser is making the right decisions. Purchaser allocations which are close to, but do not match, the suggested allocations may represent purchaser application of some other factor the system did not account for. Purchaser allocations significantly deviating from the suggested allocation should be a flag to the purchaser that they are wasting funds or should reallocate volumes.

Depending upon the implementation and/or features available to the purchaser, for example, based upon status, a graphing function may be employed. Through use of a graphing option the system can provide a visual representation of the data and/or analysis for the purchaser. In this manner, a graph may make evident something the numerical representation doesn't. The “VIEW GRAPH” button 350 invokes this function.

In other variants of FIGS. 2 or 3, additional controls may be employed to ensure that the volume or percent awarded does not exceed 100% of the portion of current needs the purchaser has decided to award. Moreover, depending upon the implementation, purchasers may be limited in the changes they can make. For example, some implementations may allow a purchaser to increase the amount to be awarded during a pending negotiation but not to decrease it so that if a purchaser's current needs are 1000 units and they decide to award 75% of needs (or 750 units), they could later decide to increase the amount to be awarded to 85% of needs, but could not decrease it to 60% of needs. Notably, applying this constraint provides some overall protection to the suppliers, but takes very little control from purchasers because they still need not award all of the amount to be awarded. Other implementations may require an allocation of the entire amount specified as to be awarded, but may allow a purchaser to decrease the amount to be awarded subject to the minimum volume. In this manner, a purchaser who is unhappy with all the products being bid can reduce their amount to be awarded to the minimum volume and then award that minimum to a single supplier to fulfill their contractual obligations. Notably, the inherent flexibility afforded purchasers allows for numerous other variations to similarly be employed to enhance efficiency, compliance, commercial acceptability, etc.

Additionally, depending upon factors such as qualification level, membership level, system usage, etc., it may be desirable to offer purchasers additional advanced features. For example, the purchaser interface may also include analysis features, display the aggregate volume to be awarded, the aggregate percentage allocated to each supplier, other individual purchaser information such as their amount to be awarded, etc.

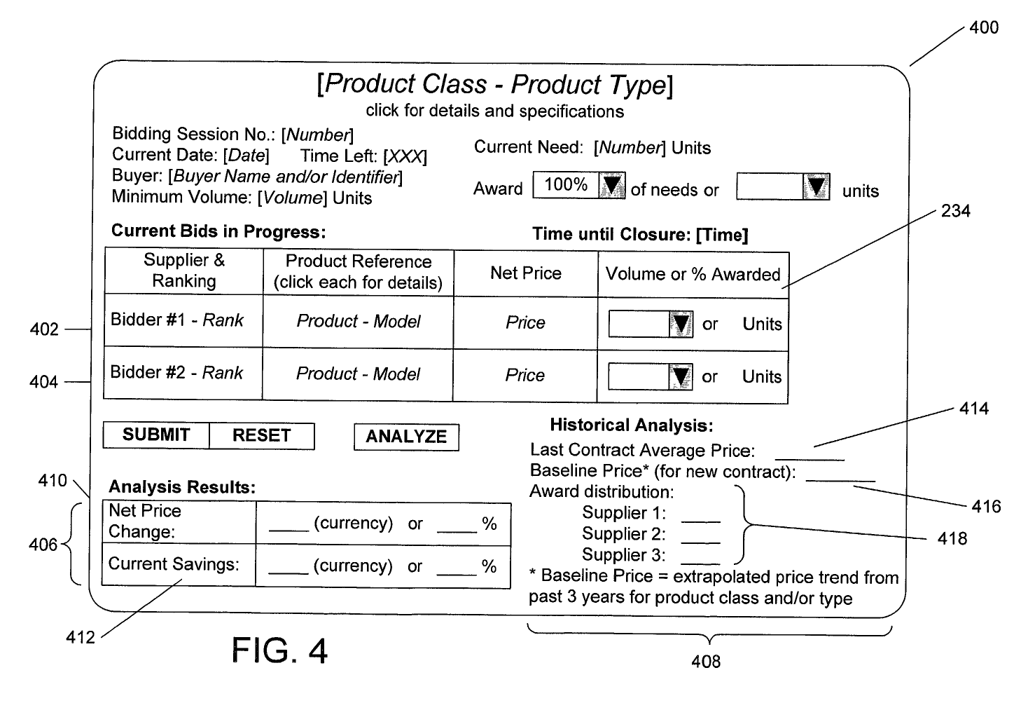

FIG. 4 is one example of an advanced purchaser screen 400. This example is similar to the example of FIGS. 2 and 3 except there are only two bidders 402, 404 and certain optional analysis features are provided. As shown, this screen includes both current 406 and historical 408 analysis information. The current analysis information 406 reflects the overall effect of the current negotiation. For example, in the current analysis, the “Net price change” 410 reflects the net change in price for the purchaser's entire allocation if one or both bidders change their price. The “Current Savings” 412 reflects the overall savings relative to the initial bid and allocation.

Similarly, the optional “Historical Analysis” 408 in this example reflects the immediately preceding negotiation for this product class and purchaser. As shown, the “Last Contract Average Price” 414 is the overall average price for the prior negotiation involving that purchaser and the particular product class and/or type from that prior negotiation. The “Baseline Price” 416 is an extrapolation from historical information taken from all negotiations involving the product class and/or type. The “Award Distribution” 418 shows the overall distribution for the prior negotiation. Notably, the prior negotiation involved three suppliers, whereas in this example the current negotiation involves only two suppliers.

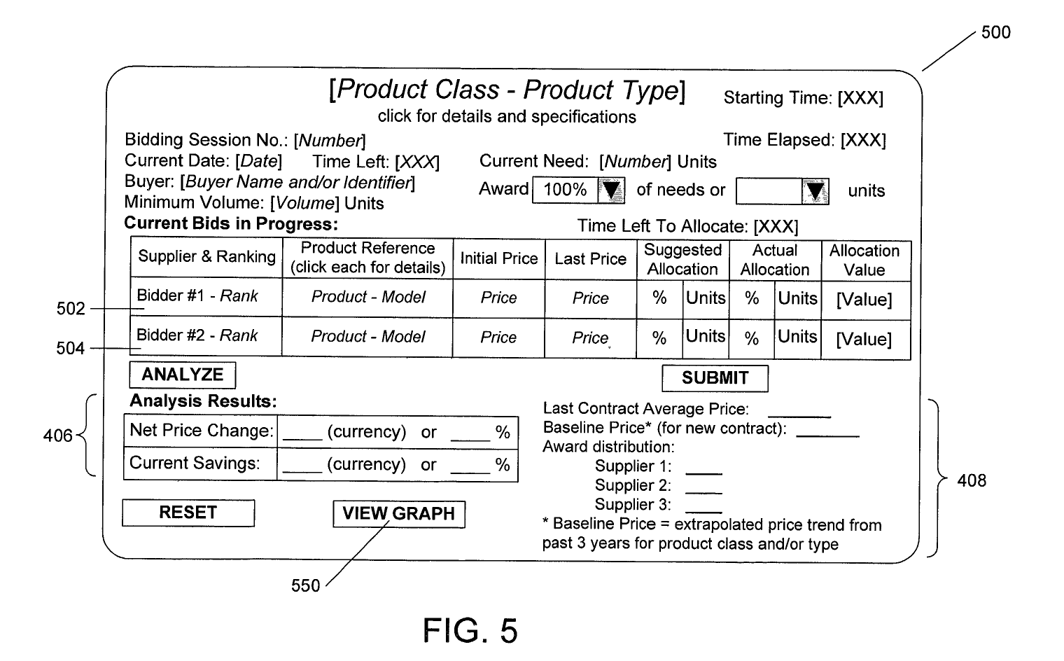

FIG. 5 is an alternative example of an Advanced Purchaser Screen 500. This example is also similar to the example interface of FIGS. 2, 3 and 4 except there are only two bidders 502, 504 and optional analysis features such as described in connection with FIG. 4 are provided namely, current 406 and historical 408 analysis information.

Unlike the Screens 200, 400 of FIGS. 2, 4, the Current Bids In Progress of FIG. 5 is set up, and operates, in the manner described in connection with the Current Bids In Progress of FIG. 3. Similarly, the Advanced Purchaser Screen 500 includes an optional graphing function as described in connection with FIG. 3, as evidenced by the “VIEW GRAPH” button 550.

### Supplier Interface

When a supplier agrees to participate in the negotiation they are given access to an interface that will be used for that negotiation. As noted above, depending upon the particular implementation, the interface may be accessed via the internet using a specific URL or Internet Protocol (IP) address, through a separate dial-up connection, through a network connection, etc. and which may also incorporate some form(s) of security to prevent unauthorized access.

When a supplier connects, for example, through the internet using a web browser, the supplier is presented with a Supplier Bid Screen. The Supplier Bid Screen allows a supplier to enter and modify their bid, by entering information regarding the specific semi-fungible commodity item offered and the price, or by revising the bid price to attempt to capture more of the volume to be awarded. In some embodiments, the supplier may be able to pre-qualify two or more products so that they can revise the offered semi-fungible commodity item as well as the price, for example to offer a higher quality item for the same bid price (rather than lowering the price) or substitute a different semi-fungible commodity item at a lower price.

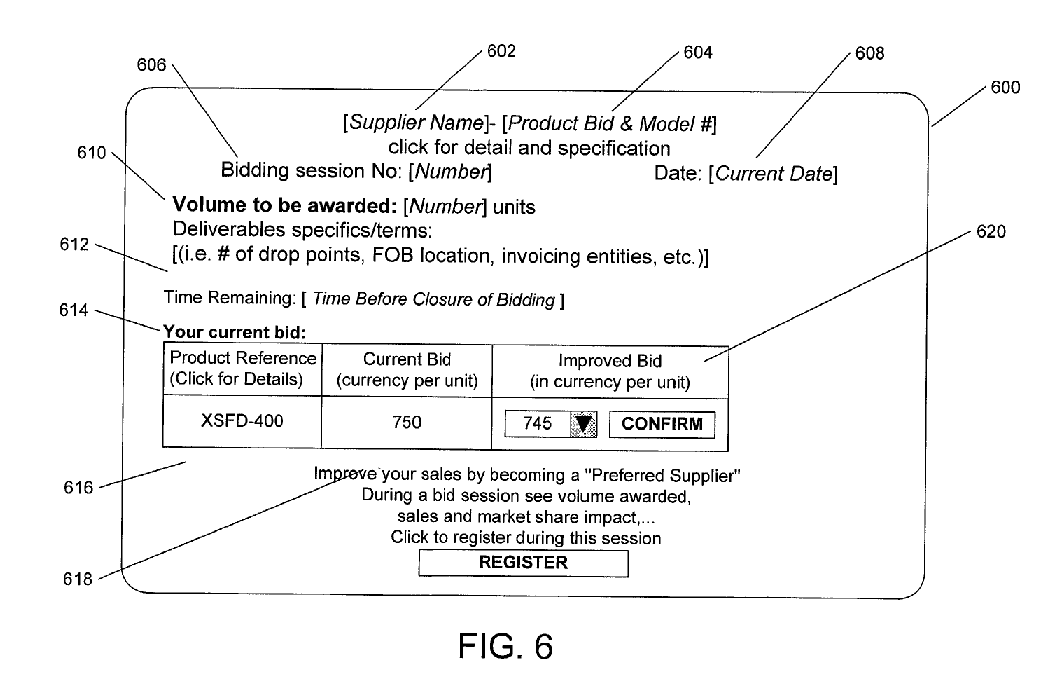

One commercially suitable example of a Supplier Bid Screen is shown in FIG. 6. As shown, the Supplier Bid Screen 600 identifies generally the supplier 602, the product being bid by the supplier 604 by name and/or model, a bidding session number 606 which is used to identify a specific bidding session, and the current date 608. Additionally, the Supplier Bid Screen 600 may show the aggregate volume to be awarded 610, any specifics pertaining to the deliverables 612, such as the aggregate number of drop points, whether the products are to be FOB supplier or purchaser, the number of invoicing entities, payment net 30, 60 or 90 days, etc. As with the Purchaser Screen 200, 400 of FIGS. 2 or 4, a Time Remaining counter 614 is provided.

The Supplier Bid Screen 600 also identifies the particular product being bid 616, for example the XSFD model 600, the current bid price 618, for example 750 (currency units) and provides a way for the supplier to enter an “improved” or reduced bid price 620, for example by typing in an amount or using a pull down box and confirming the entry. In this manner, the supplier has a current view of their current bid. If the supplier enters an improved bid, the current bid is updated in real-time to reflect the changed bid.

Although the information provided on the Supplier Bid Screen 600 of FIG. 6 is more than sufficient to allow a supplier participate in the negotiation, by providing additional information to the supplier, the supplier can be encouraged to become a more dynamic participant in the negotiation. One such way to provide some additional supplier information is through use of a “Preferred Supplier Bid Screen” which is accessible to a supplier only upon, for example, reaching a particular level of usage, payment of a fee, reaching a specified status, etc.

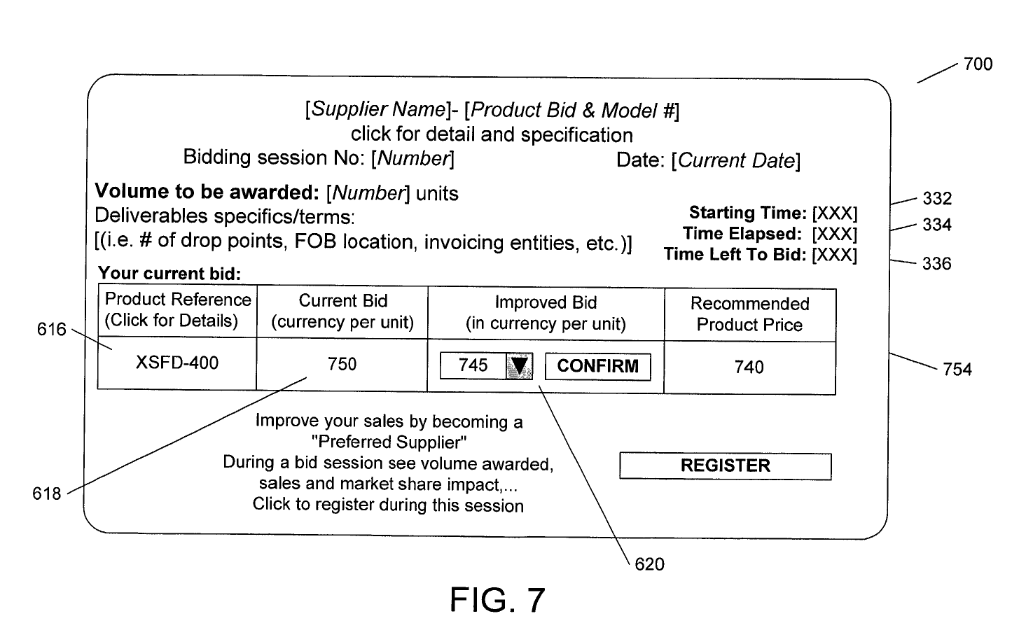

Another commercially suitable example of a Supplier Bid Screen 700 is shown in FIG. 7. As shown, the Supplier Bid Screen 700 is similar to the Supplier Bid Screen 600 of FIG. 6 except, unlike the Supplier Bid Screen 600 of FIG. 6, this negotiation is set up for quasi-real-time operation. Accordingly, it contains “Starting Time” 332, “Time Elapsed” 334, and “Time Left To Allocate” 336 indicators such as described in connection with FIG. 3.

Additionally, a “Recommended Product Price” indicator 754 is also included in the Supplier Bid Screen 700. This “Recommended Product Price” indicator 754 provides a recommendation of a price target identified by the server. Its purpose is to assist a supplier in determining whether to lower their price based upon some factor, for example, other supplier bids of their semi-fungible items.

Depending upon the particular implementation, this amount may be derived from, for example, analyzing price changes, on a percentage basis, made by one or more other suppliers. For example, suppliers having the greatest allocation, receiving the largest percentage of a reallocation, receiving a reallocation following a price change, etc. to name a few can form the basis for the value presented in this indicator. Alternatively (and/or additionally) if the system incorporates a decision making tool option, for example, from among those described in greater detail below, the output of the decision making tool can be used to obtain the “Recommended Product Price” indicator 754.

If the supplier enters an improved bid, the current bid is updated form the purchaser perspective at the end of the bid cycle to reflect the changed bid.

Although, as with the Supplier Bid Screen 600 of FIG. 6, the information provided on the alternative Supplier Bid Screen 700 of FIG. 7 is more than sufficient to allow a supplier participate in the negotiation, by providing additional information to the supplier, the supplier can similarly be encouraged to become a more dynamic participant in the negotiation by providing some additional supplier information is through use of a “Preferred Supplier Bid Screen” which is accessible to a supplier only upon meeting some criterion or criteria.

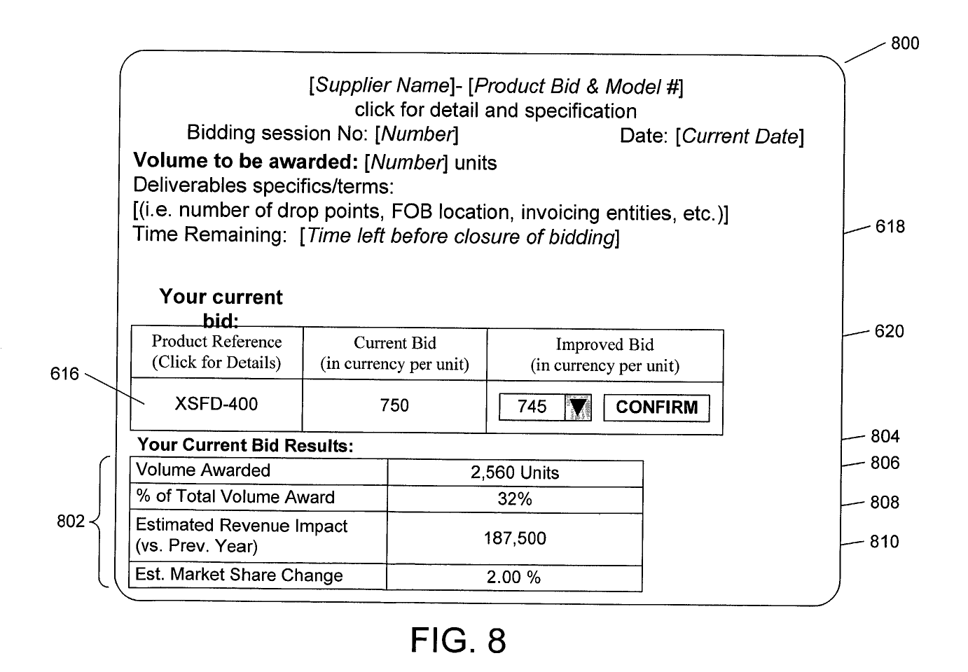

FIG. 8 is a representative example of a Preferred Supplier Bid Screen 800. As shown, the Preferred Supplier Bid Screen 800 contains the same basic information as the Supplier Bid Screen 600 of FIG. 6. However, in addition to the basic information, the Preferred Supplier Bid Screen 800 includes additional “Current Bid Results” 802 information which allows a supplier to more dynamically react to the negotiation as it progresses. Depending upon the implementation, that information may rely, in part, upon information provided by the supplier such as unit volumes, average or list price, current market share, or historical information. Alternatively, the information may include historical data gathered or retained by the system from previous negotiations involving that supplier and/or semi-fungible commodity item.

For example, the Preferred Supplier Bid Screen 800 may show the actual aggregate volume awarded by the purchaser(s) 804 based upon the current price bid by the supplier, the award calculated as a percentage of the total volume 806, the estimated impact of the bid on sales and/or revenue versus some prior indicator 808 such as previous negotiation, period or year, and/or an estimated change in market share 810 based upon the volume to be awarded.

By way of example, as illustrated in FIG. 8, the supplier's current bid 618 is 750/unit. As a result, if the negotiation ended at that instant, the supplier would be awarded 2,560 units which represent 32% of the total volume to be awarded. In this example, the supplier has provided historical information regarding revenues for the semi-fungible commodity item being bid. As a result, the system calculates that the current volume would result in an estimated increase in revenue over the previous year of 187,500 and a two percentage point increase in market share.

As with the Supplier Bid Screen 600 of FIG. 6, if the supplier decreased the price being bid, the Current Bid Results 802 information will be updated in real-time. However, unlike the Supplier Bid Screen 600 of FIG. 6, the Current Bid Results 802 allow a supplier to immediately see the effect of a price change on the volume allocated to them.

Depending upon the particular implementation, and/or possibly the product category for the semi-fungible commodity item, some of the information illustratively shown in the Preferred Supplier Bid Screen 800 of FIG. 8 may also or alternatively be present in the Supplier Bid Screen. For example, in some implementations, the Supplier Bid Screen may indicate the volume to be awarded and the volume awarded as a result of the current bid. In others, the total volume to be awarded may known to the system but be broadly indicated to bidding suppliers as a range, for example “7,500 to 10,000 units” and the actual volume awarded may be provided in units or as a percentage of the volume to be awarded so that the overall aggregate volume may not be ascertainable by the supplier.

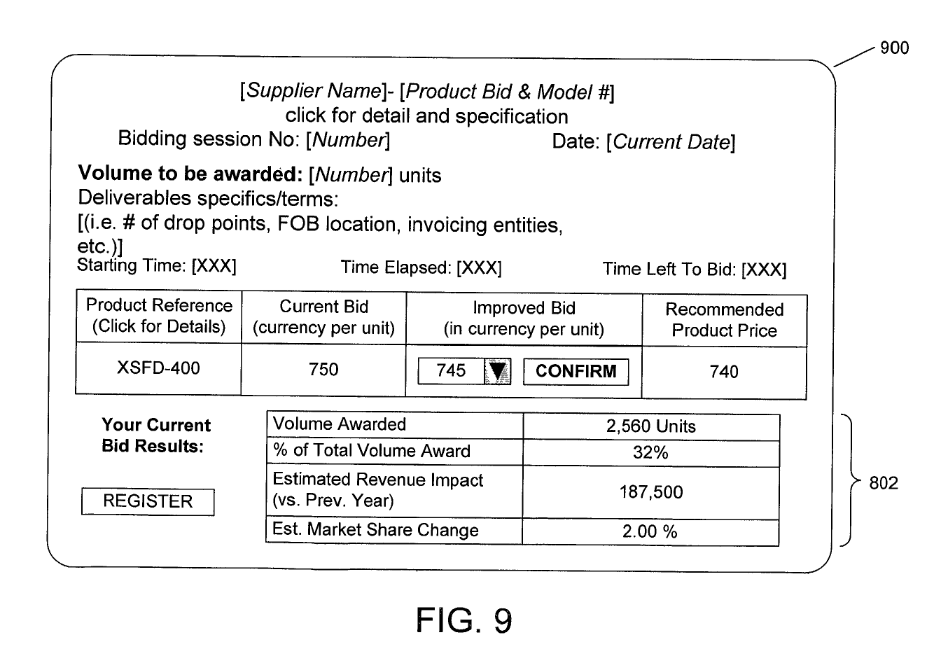

FIG. 9 is a representative alternative example of a Preferred Supplier Bid Screen 900. As shown, the Preferred Supplier Bid Screen 900 contains the same basic information as the Supplier Bid Screen 600 of FIG. 6. However, in addition to the basic information, the Preferred Supplier Bid Screen 900 includes additional “Current Bid Results” 802 information similar to that shown and described in connection with FIG. 8.

As with the Supplier Bid Screen 800 of FIG. 8, if the supplier decreased the price being bid for FIG. 9, the Current Bid Results 802 information will be updated, although it would be done in quasi real-time as with FIG. 7.

Depending upon the particular implementation, and/or possibly the product category for the semi-fungible commodity item, as with the Preferred Supplier Bid Screen of FIG. 8, some of the information illustratively shown in the Preferred Supplier Bid Screen 900 of FIG. 9 may also or alternatively be present in one of the Supplier Bid Screens of FIG. 6 or FIG. 7.

Additional information or analysis appropriate for the negotiation may be provided on the Supplier Bid Screen, the Preferred Supplier Bid Screen or both, the particular specific information being related to the needs or desires of the participants, the host or factors unimportant for an understanding of the principles of the invention.

Having described principles of the invention in connection with various discrete components, the principles will now be further described by way of two example product negotiations.

### EXAMPLE #1

In this first example, there are three purchasers (A, B and C) who all have needs for the same product class (but not necessarily the same type within the class). Their volume needs are also different.

A needs 5000 units

B needs 3000 units

C needs 2000 units

Each purchaser selects all the qualified suppliers they would be willing to potentially purchase from, for example through a customary Request For Proposal (RFP) for that semi-fungible commodity item product class and/or type submitted to the entity hosting the negotiation. In each RFP, each purchaser defines the general terms (delivery date(s) and location(s), minimum quantity or lot size, payment terms, etc.). Alternatively, purchasers can submit their RFPs and optionally, identify any suggested suppliers. In this alternative, the negotiation host or their agent contacts the prospective suppliers and those who respond favorably are then qualified, if they had not previously done so. Moreover, if the negotiation was to be fully or partially blind, the negotiation host or agent would act as a screen or conduit for the RFP information so as to insure that, to the extent reasonably possible, the identity of the purchaser was not directly or indirectly revealed.

Once they have submitted their response to the RFP and been qualified, the suppliers are then contacted as to the date and time for the start of the online price negotiation session. In this example, suppliers U, V, W, X, Y and Z have responded to the RFP, with purchaser A having identified suppliers U and X, purchaser B having identified U, V, Y Z, purchaser C having identified V, X and Z, and supplier W having been identified by the negotiation host. Based upon the qualification requirements imposed, only suppliers X, Y and Z qualify for the negotiation session. The session is specified to last 4 hours and all purchasers and all suppliers are connected via the internet using personal computers with web browsers and are on-line for the entire term of the session. In this session the following ground rules also apply: suppliers may only reduce prices, purchaser minimum allocation is 100 units, and once a purchaser indicates an overall portion of their current needs to be awarded, they may not change that amount during the session.

As the session begins, the purchasers see the initial price per unit that the suppliers have initially committed to reflected on their displays. Based on this price per unit, the purchasers each allocate volume to one or more suppliers based upon whatever criteria that purchaser deems important.

As the allocation occurs, those allocations are reflected on the supplier's displays so that they can see how much total volume has been allocated to them by all the purchasers in aggregate, based on the price that they have committed to.

As a result, the interactive and dynamic aspects come into play in a series of iterations.

Assume the prices that the suppliers have initially committed to are:

X: $100/unit for product “Q”,

Y: $11 0/unit for product “E”, and

Z: $120/unit for product “K”.

Based on these prices each Purchaser allocates their volume needs as shown in Table 1:

TABLE 1

| | | Supplier X | Supplier Y | Supplier Z |
|---|---|---|---|---|
| Purchaser | Volume | Q @ $100/unit | E @ $110/unit | K @ $120/unit |
| A | 5,000 | 4,000 | | 1,000 |
| B | 3,000 | | 3,000 | |
| C | 2,000 | 1,000 | 1,000 | |
| TOTAL | 10,000 | 5,000 | 4,000 | 1,000 |

Those allocations are reflected on the supplier's screens. Thus, each supplier sees the volume it was awarded in units and/or in % of the total volume. In this case, X sees an initial award of 5000 units or 50%, Y sees an initial award of 4000 units or 40%, and Z sees an initial award of 1000 units or 10%.

Assume that product “K” bid by supplier Z is of a higher quality or materially different product which justifies a price premium over the products bid by suppliers X and Y. Nevertheless, supplier Z is not happy with being awarded only 10% of the volume and consequently enters a lower price, reducing the price bid from $120 to $115/unit.

That change is reflected on each purchaser's screen so that each purchaser will see the new price of $115/unit for product “K” from Supplier Z.

As a result, at least one of the purchasers decides to change their volume allocation as shown in Table 2.

TABLE 2

| | | Supplier X | Supplier Y | Supplier Z |
|---|---|---|---|---|
| Purchaser | Volume | Q @ $100/unit | E @ $110/unit | K @ $110/unit |
| A | 5,000 | 3,000 | | 2,000 |
| B | 3,000 | | 2,000 | 1,000 |
| C | 2,000 | 1,000 | | 1,000 |
| TOTAL | 10,000 | 4,000 | 2,000 | 4,000 |

This reallocation causes an update of each supplier's screen. Note that even though suppliers X and Y did not change their price, the volume awarded to them has changed. As a result, supplier X now sees an award of 4000 units or 40%, Y sees an award of 2000 units or 20%, and Z sees an award of 4000 units or 40%.

This, in turn, may trigger one of the suppliers to again modify its price to try to recapture some of the volume lost or get more volume. Several more iterations occur before the 4 hours for the negotiation elapses at which time all allocations and prices become fixed. Alternatively, and advantageously, the negotiation can be operated like an auction so that once the negotiation period expires, the session can continue beyond the expiration time as long as pricing and volume are changing during a specified period or cycles. For example, the system can be set up such that when the 4 hour time elapses, if any participant updates their allocation or price within one minute, the negotiation continues. If one minute elapses with no change in allocation or price, the negotiation closes.

### EXAMPLE 2

In this example, there are two different purchasers (1 and 2) who both have needs for the same product class (but not necessarily the same type within the class). Their volume needs are also different—purchaser 1 needs 45,000 units and purchaser 2 needs 15,000 units.

Suppliers are identified and qualified in one of the manners described above.

Based upon the qualification requirements imposed, suppliers K, L, M and P qualify for the negotiation session. The session is specified to last 2 hours and all purchasers and all suppliers are again connected via the internet and are on-line for the entire term of the session. In this session the following ground rules also apply: suppliers may only reduce prices, purchaser minimum allocation is 1000 units, and a purchaser may modify the portion of their current needs to be awarded upwards or downwards during the session but may not reduce the portion of their current needs to be awarded to less than 50% of their “current needs” amount. In other words, if a purchaser enters a current need of 10,000 units and the amount to be awarded as 8,000 units, they can reduce the amount to be awarded during the session to no less than 5,000 units.

As with example 1, when the session begins, the purchasers see the initial price per unit that the suppliers have initially committed to reflected on their displays. Based on this price per unit, the purchasers each allocate volume to one or more suppliers based upon whatever criteria that purchaser deems important. As the allocation occurs, those allocations are reflected on the supplier's displays so that they can see how much total volume has been allocated to them by all the purchasers in aggregate, based on the price that they have committed to.

Assume the prices that the suppliers have initially committed to are:

K: $70/unit for product “a”,

L: $1 00/unit for product “b”,

M: $75/unit for product “c”, and

P: $88/unit for a 50% split of products d and h.

Based on these prices purchaser 1 decides to award 40,000 units of the 45,000 unit current needs and purchaser 2 decides to award 10,000 units of the 15,000 unit current needs. They each initially allocate their volume needs as shown in Table 3:

TABLE 3

| | | Supplier K | Supplier L | Supplier M | Supplier P |
|---|---|---|---|---|---|
| | | a @ | b @ | c @ | d & h @ |
| Purchaser | Volume | $70/unit | $100/unit | $75/unit | $88/unit |
| 1 | 40,000 | 10,000 | | 20,000 | 5,000 |
| 2 | 10,000 | | 5,000 | 3,000 | 2,000 |
| TOTAL | 50,000 | 10,000 | 5,000 | 23,000 | 7,000 |

Those allocations are reflected on the supplier's screens. Thus, each supplier sees the volume it was awarded in units and/or in % of the total volume.

As a result, supplier L reduces the price for product “b” to $85.

That change is reflected on each purchaser's screen so that each purchaser will see the new price of $85/unit for product “b” from Supplier L.

This causes purchaser 1 to decrease the amount to be awarded to 35,000 units while purchaser 2 increases the amount to be awarded to the full 15,000 units and a reallocation is made as follows as shown in Table 4:

TABLE 4

| | | Supplier K | Supplier L | Supplier M | Supplier P |
|---|---|---|---|---|---|
| | | a @ | b @ | c @ | d & h @ |
| Purchaser | Volume | $70/unit | $85/unit | $75/unit | $88/unit |
| 1 | 35,000 | 8,000 | 5,000 | 22,000 | |
| 2 | 15,000 | 2,000 | 10,000 | 2,000 | 1,000 |
| TOTAL | 50,000 | 10,000 | 15,000 | 24,000 | 1,000 |

This reallocation causes an update of each supplier's screen. Note that even though purchasers 1 and 2 both changed their amount to be awarded, since the total amount be awarded of 50,000 units did not change, the suppliers are unaware that the purchasers did so. As with example 1, suppliers L, M and P see that the volume to be awarded to them has changed, however supplier K will not notice any change because the total volume and the total allocation to them has not changed.

Supplier M then modifies their price downward to $73/unit. This triggers a further reallocation as shown in Table 5:

TABLE 5

| | | Supplier K | Supplier L | Supplier M | Supplier P |
|---|---|---|---|---|---|
| | | a @ | b @ | c @ | d & h @ |
| Purchaser | Volume | $70/unit | $85/unit | $73/unit | $88/unit |
| 1 | 35,000 | | 5,000 | 30,000 | |
| 2 | 15,000 | 2,000 | 10,000 | 3,000 | |
| TOTAL | 50,000 | 2,000 | 15,000 | 33,000 | |

As a result, supplier P sees their total allocation disappear and, in the last seconds of the session modifies their bid to purely product “h” at $75/unit. This triggers a further reallocation as shown in Table 6:

TABLE 6

| | | Supplier K | Supplier L | Supplier M | Supplier P |
|---|---|---|---|---|---|
| | | a @ | b @ | c @ | h @ |
| Purchaser | Volume | $70/unit | $85/unit | $73/unit | $75/unit |
| 1 | 35,000 | | 5,000 | 30,000 | |
| 2 | 15,000 | | 8,000 | 3,000 | 4,000 |
| TOTAL | 50,000 | | 13,000 | 33,000 | 4,000 |

Immediately after the session time limit elapses, supplier K drops their price to $68/units causes an immediate reallocation by purchaser 1 as shown in Table 7:

TABLE 7

| | | Supplier K | Supplier L | Supplier M | Supplier P |
|---|---|---|---|---|---|
| | | a @ | b @ | c @ | h @ |
| Purchaser | Volume | $68/unit | $85/unit | $73/unit | $75/unit |
| 1 | 35,000 | 5,000 | 5,000 | 25,000 | |
| 2 | 15,000 | | 8,000 | 3,000 | 4,000 |
| TOTAL | 50,000 | 5,000 | 13,000 | 28,000 | 4,000 |

No further changes occur within a specified 5 minute activity limit and the negotiation closes.

Depending upon the particular implementation other variants are also possible for example, an activity timer can be included such that if there is no activity for a prescribed amount of time during the session the negotiation closes, even if the session time limit has not expired. This variant encourages action and prevents the parties from “sitting” on their positions until the very end of the session. In other cases, the activity timer can be triggered only by a purchaser modification or vice-versa. In still other cases an iteration limit can be imposed, either alone or as an alternative to the session time limit. Thus, for example, the parties to the negotiation can specify that if 10 iterations are reached before the session expiration, the negotiation closes or that the negotiation closes on the third iteration following session expiration.

In the quasi-real-time variants, the above would occur in a similar fashion except that, as described above, certain actions would only be effective during the appropriate allocation or bidding cycle.

### Service Related Variants

Service related variants operate in a similar manner to the product related variants except that, in some cases, instead of supplier prices going down during the negotiations, values (representative of the level of service offered) go up as the negotiation proceeds. In other cases, where the specific service offer remains fixed, e.g. repave a section of a parking lot, those offerings can be treated in an identical manner to a product offering.

Thus, it should be recognized that by straightforward application of the teachings herein, the term “product” as used herein can generically and interchangeably apply to a true product item, a service and/or rights, depending upon the particular case, irrespective of whether the prices go up or down or exploitation of rights is involved.

### Optional Decision Support Features

Having described a number of different variants employing the principles of the invention, additional variants employing decision support features will now be described.

In these variants, additional tools are provided to purchasers and/or sellers to assist them during the negotiation and in the decision making process preceding the negotiation. Depending upon the particular implementation, the availability of these tools may be dependent upon a specified condition such as payment of a fee, reaching a certain transactional level, etc. Alternatively, the tools may be part of the basic implementation.

The tools are intended to assist purchasers in allocating their volumes in an economically efficient manner and/or to induce sellers or service suppliers to be more responsive to the reactions of buyers .

As noted above, the simplest decision making tool is implemented by allowing a supplier to view, for example, one or more other competitive supplier's prices, the lowest price, and/or purchaser allocations to that supplier or to one or more of the other suppliers. Of course, more complex decision making tools can also be employed, for example, tools using multi-attribute decision analysis techniques, Decision analysis is the discipline of evaluating complex alternatives in terms of values (what is cared about) and uncertainty (what is known and not known). The benefits of decision analysis are insight into how the defined alternatives differ from one another in terms of their overall value to the decision maker and suggestions for generating new and improved alternatives.

There are numerous decision making tools of this type commercially available. Examples include HIPRE 3+ which is available from Helsinki University of Technology or its on-line counterpart Web-HIPRE. The HIPRE program is a multi-attribute decision analysis tool for value trees and AHP. Web-HIPRE is a Java-applet for multiple criteria decision making based on the well-known decision support software HIPRE 3+. Web-HIPRE supports several weighting methods including AHP, SMART, SWING, SMARTER and value functions. Analysis results are shown graphically and numerically. Other suitable decision making tools include, for example, “Criterium Decision Plus” from InfoHarvest, Inc., PO Box 25155-2055, Seattle, Wash. 98125-2055; “GeNIe” from the Decision Systems Laboratory of the University of Pittsburgh; “Logical Decisions” from Logical Decisions, 1014 Wood Lily Dr., Golden, Colo., 80401, or many other programs enabling analysis using multi attribute utility theory.

In order to create a useful decision analysis model, it is necessary to not only create the model but to determine the probabilities and values to populate the model for computation. Depending upon the particular implementation and factors such as: user sophistication, known user bias or preference, the availability and/or measurability of differences, etc., the values used for populating the analysis tool can be supplied by, for example, the supplier and/or manufacturer of the semi-fungible commodity item, obtained from available information in the negotiation system, or from some third party source. Additionally, value weights can similarly be assigned, or can be assigned by the purchasers based upon their own initial assessment of the tradeoffs among objectives, and preferences.

Ultimately, each semi-fungible commodity item offered has an assigned utility value which will not change during the negotiation. Thus, for each semi-fungible commodity, at each point in time, there will be a pair of numbers indicating respectively the price and utility value for the item.

In one variant, a curve representing the best fit for all the points for a particular purchaser can be plotted from points defined by those pairs, the resultant curve being called the utility function.

In another variant, a linear relationship can be assumed or imposed. In that variant, two prices and utility values are used to define a linear utility function. Thus, any other product having a utility value can have a price associated with it using that linear utility function or vice versa.

Depending upon the variant, when plotted, the shape of the utility function can either be linear or exponential.

Similarly, in some variants, through prompting an acceptable deviation from the utility function can be numerically ascertained, for example, based upon inputs from the purchaser in the form of a range or through further prompting. In other words, a purchaser could be prompted for a utility value and range, i.e. 54±3 and/or a price and range 85±5. In this manner, the values can be used to define the utility function and the ranges can be used to define a “price utility band” also called a “utility function band”. The advantage of using the band being that it allows for a margin of error and/or accounts for a lack of precision on the part of the purchaser with respect to the utility function.

Once the negotiation begins, the utility function curve or band moves either concurrently with or on a change of cycle due to changes in price. In this manner, feedback is immediate and participants viewing the results can factor them in to the next step in the negotiation.

Specifically, based upon the initial price and an assigned weighted utility of each semi-fungible commodity item alternative, each offering can be plotted and viewed relative to the curve or band.

In the first of the two immediately preceding variants, if this technique is employed for “pure” or wholly fungible commodity items, the curve would actually be a straight vertical line and decisions could be made solely based upon price. In the second, the utility function is linear and has a slope that is indicative of a tradeoff being made between price and utility among the commodity items due to their semi-fungible nature.

In either case, because the offered commodity items are semi-fungible, tradeoffs and their importance to the purchaser must be taken into account. In the first of the two immediately preceding variants, by graphically displaying the curve or band, purchasers can allocate quantities more efficiently since allocations to products whose price falls on or below the curve, or within or below the band boundaries, represents good value for the price (i.e. efficient use of capital), whereas allocations above the curve or upper band boundary represents poor use of capital and may signal that a re-allocation should be considered. In the second, a reference price supplied by the purchaser can be used to identify a relationship that allows for identification of good and/or poor use of capital and signaling of the purchaser if a re-allocation should be considered.

Thus, it will be recognized that augmenting a negotiation with a decision analysis tool is a valuable and desirable feature well suited for negotiations involving semi-fungible commodity items.

A negotiation employing such optional decision making tools can generally be though of as having three conceptual components, although depending upon a particular implementation, those components may be combined, further separated and/or partially intermixed.

One component is a multi-attribute decision making tool which is used to determine the utility of each semi-fungible commodity item. Another component is the determining of the buyer's own utility function for money with reference to the specific semi-fungible commodity item category that will be the subject of the negotiation. The third component is the negotiation itself where quantity allocation is made, either across vendors, or to a single vendor based on the best match of the buyer's own parameters for an item and information gleaned from the utility/price curve.

Employing the first component involves the particular multi attribute utility analysis according to the specific program used. In general this involves, laying out the applicable criteria, having the purchaser assigns weights and utility values to each criteria using for example, utility functions, direct assessment, pair-wise comparison, etc., and calculating the overall utility for each semi-fungible commodity item.

Through a simple example, advantages and features of variants employing a multi attribute decision making tool can be demonstrated.

Assume that a negotiation will involve three semi-fungible commodity items “A”, “B” and “C” having respective overall utility values of 70, 35 and 12 (i.e. A=70; B=35; C=12).

Each purchaser who will be a party to the negotiation will be prompted to calculate their own utility for the money or “pricing position”. This part is typically subjective for each purchaser. Moreover, the specific technique employed for this part will depend upon the particular implementation. For example, a purchaser can be prompted to select at least three of the semi-fungible commodity items, one having the highest acceptable utility value, one having the lowest acceptable utility value and at least one having an acceptable utility somewhere in between. The purchaser can then be prompted to specify a pricing position assigning prices they would be willing to pay for each item of interest. Depending upon the particular case, the price and/or utility values could be the actual values specified or they could be normalized, so that the values fall within a common or a specified range.

For example, in the case of normalized values, the purchaser could be asked to assume the price for the highest utility item is 100 and indicate what price they would be willing to pay for the lowest utility item. They could then be similarly prompted for one or more items in between or prices for the items in between could be extrapolated based upon the utility values.

In other variants, a price for the lowest utility item could be assigned, for example automatically given the value 1, or actually specified by the purchaser; the purchaser then being prompted for amounts relative to the priced item identifying how much more they would be willing to pay for the additional utility offered by the other items. Depending upon the particular implementation, as noted above, the values could then be normalized, for example, to a range of between 0 and 100, 50 and 1000, etc.

These values can then, if desired, be represented in tabular form, such as shown in Table 8.

TABLE 8

| Item | Utility | Price |
|---|---|---|
| A | 70 | 100 |
| B | 35 | 83 |
| C | 12 | 57 |

Additionally, they can be represented in graphical form as discrete points 1002, 1004, 1006 or on a curve derived from those values, for example as a “utility function” curve.

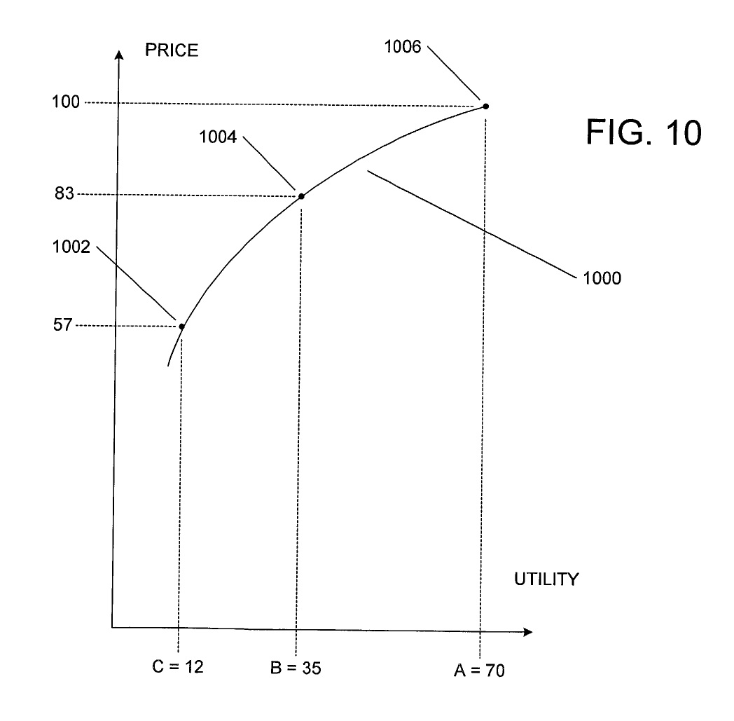

The utility function associated with the values indicated by the purchaser is calculated, for example, using a fitting function such as a standard exponential curve fitting techniques, thereby defining a price vs. utility curve 1000 based upon the three pairs of values from Table 8, such as is shown in FIG. 10.

Similarly, had range values been provided, those values could be used to define a band about the curve, for example, in a simple case, by adding and subtracting the range values to obtain two curves parallel to the utility curve and defining the band in between or, in a more complex case, by calculating new curves above and below by adding the ranges to the values to define new points for which an upper curve can be calculated, and subtracting the ranges from the values to define new points for which a lower curve can be calculated, the area between the upper and lower curve being the defined utility function band.

In other variants, the importance of price and utility can both be taken into account by assuming an inverse relationship between price and utility. For example, assume that three supplier products (“A”, “B” and “C”) have utility values respectively of A=80, B=65 and C=55 based upon a purchaser's inputs. Once received, the highest utility value product is assigned a reference price, in this case a normalized value of 100. The purchaser is prompted to specify either the importance of price or utility (typically as a percent) so that the relative preference in importance between the two can be specified as two percentages together totaling 100% (i.e. price 30%, utility 70%; price 55%, utility 45%; price 85%, utility 15%). A linear relationship between the price and utility that takes the preferences into account can then be calculated according to formula 1.

S=(U*X)/(P*Y) (1 )

Where:

S=the slope of the line;

U=the percentage attributed to the utility preference;

P=the percentage attributed to the price preference;

X=the utility value attributed to the product with the highest utility; and

Y=the reference price assigned to the product with the highest utility.

Thus, assuming a price-utility preference for the example of this variant of P=30% and U=70% and a normalized reference price of 100, the slope becomes: (0.70*80)/(0.30*100)=S=1.867.

Accordingly, under this variant it will be apparent that a slope of zero (i.e. a horizontal line) indicates a solely price based preference. A near vertical line (i.e. a slope approaching infinity) indicates a nearly 100% utility preference. Of course, under this variant, values that would result in a zero appearing in the denominator should not be used, since it would mathematically result in an infinite slope).

In some variants, to do so, a nominal range can be created and used to prevent the possibility of a “divide-by-zero” problem (infinite slope) and/or ensure that no product or service carries an internal value of 100 or zero for purposes of calculation. This can be accomplished in several ways. In one representative case, the system can calculate the utility values based upon a single threshold value provided by the prospective purchaser and information provided by suppliers as part of the qualification and/or selection process.

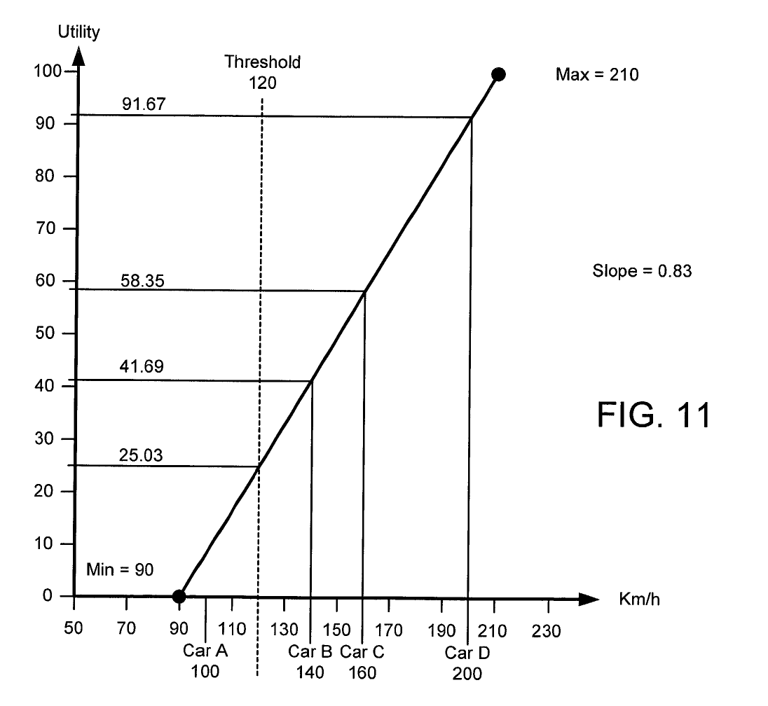

For example, assume that several police departments will collectively negotiate with several automobile manufacturers for a fleet of vehicles. Five automobiles from different manufacturers will be offered. One of the vehicles has a top speed of 100 km/h, another 140 km/h, the other two have top speeds of 160 km/h and 200 km/h respectively. If the utility is based upon top speed, a nominal range can be created by taking, for example 10% of the lowest top speed, adding it to the highest vehicle top speed and assigning that hypothetical vehicle a utility value of 100, and subtracting the value from the vehicle with the lowest top speed and assigning that hypothetical vehicle a utility value of 0. The utility values for all the actual vehicles can then be derived based upon a line connecting the two. This is shown in FIG. 11. Thus, if one police department requires, as a purchase threshold, a minimum to speed of 120 km/h, that corresponds to a utility value of 25.03 and vehicles having a utility value greater than that number will be used in the negotiation. Alternatively, the threshold can be used directly to identify those vehicles that have a top speed in excess of the threshold and their utility values can be obtained using the line.

Once the slope has been obtained, reference prices for the other products may be obtained using the one reference price, the utility values and the calculated slope.

In addition, each purchaser is typically prompted as to whether they will initially allocate their entire amount of “current needs to be awarded” to one of the items (A, B, or C) or if that amount will be spit among two or more and in what proportion.

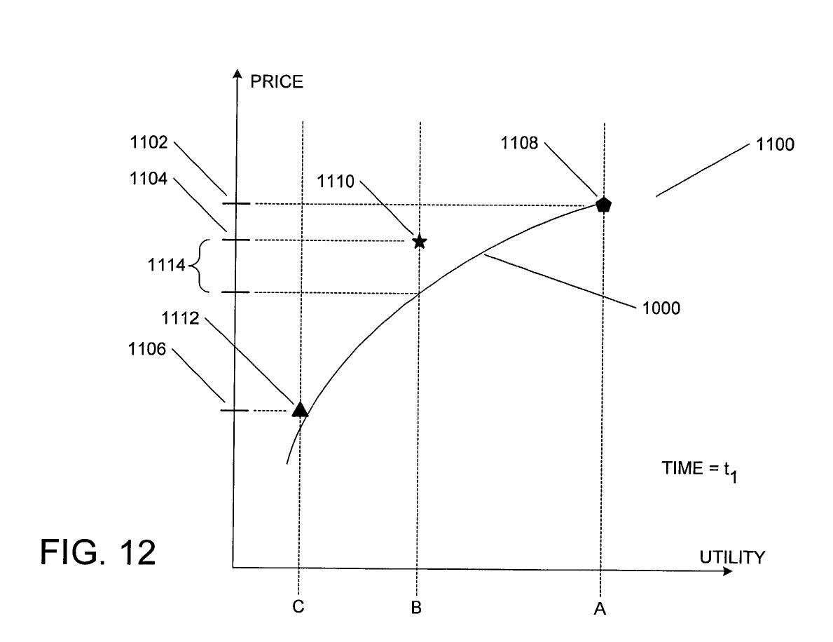

Once the preliminary allocation is complete for all product purchaser participants, the negotiation can begin. Assuming that one of the purchasers is using the optional decision making tools which provides a graphical display, that purchaser will see the prices and utilities they specified represented in FIG. 12 by a display 1200, in the form of a utility function curve 1000, such as shown in FIG. 10. In addition, in this example, at the start of the negotiation t₁ the purchaser will also see the current suppliers' offering price 1202, 1204, 1206 for each relevant item 1208, 1210,1212 in the negotiation represented as superimposed points, such as illustratively shown in FIG. 12 by a pentagon, star and triangle respectively, for items “A” 1208, “B” 1210 and “C” 1212.

As the product negotiation progresses, the plotted points are updated to reflect changes in price. Thus, the points will move down, over time, as more competitive prices are presented by suppliers. The purchaser allocates volumes as described above, however the purchaser's decision is assisted by the information provided. That is, the purchaser allocates based upon what offering price is on or below their utility curve.

Thus, as shown in FIG. 12, at time t₁ the best value for money, according to this purchaser's preferences, is item A because the price (shown by the pentagon) is on the utility function curve, whereas the price for item B is significantly above the curve and the price for item C is just above the curve.

Consequently, the purchaser should allocate the entire volume to product A. Depending upon the particular implementation options, the purchaser can be specifically prompted to perform the allocation, the system can automatically allocate volume to item A, or the purchaser can be left to their own choice which may, or may not, take into account the graphical output of the decision making tool feature.

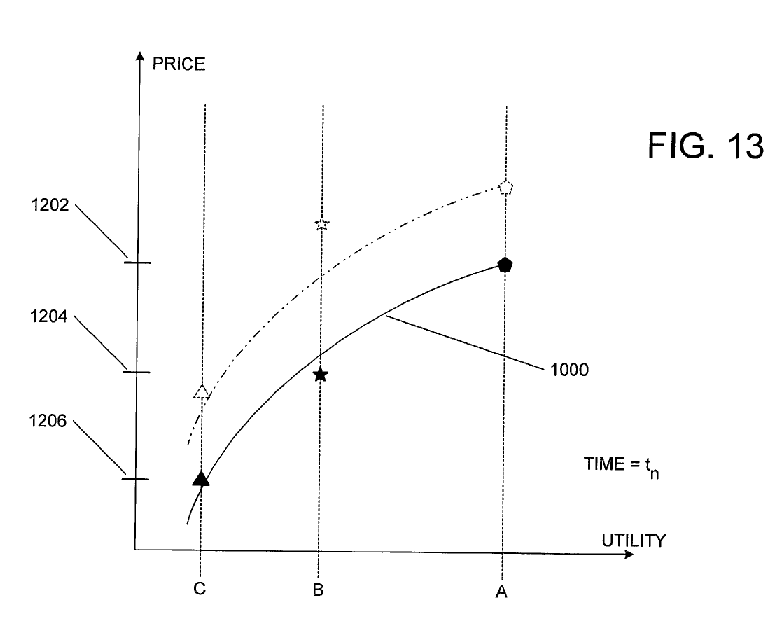

As the negotiation progresses, suppliers adjust their prices so that, as shown in FIG. 13, at time tₙ, products A, B and C have each been offered at lower prices 1302, 1304, 1306. Since the utility function curve 1000 represents the purchaser's preferences, its shape remains fixed for the negotiation, but it moves downward along with changes in price so that, for example, depending upon the particular implementation parameters, the normalization point is always on the curve, the item with the greatest allocation is always on the curve, the most recently updated price falling on or below the curve is placed on the curve, the price change immediately preceding the most recently updated price is placed on the curve, or in the most typical case, the lowest point intersecting the curve is placed on the curve so that all other points are on or above the curve.

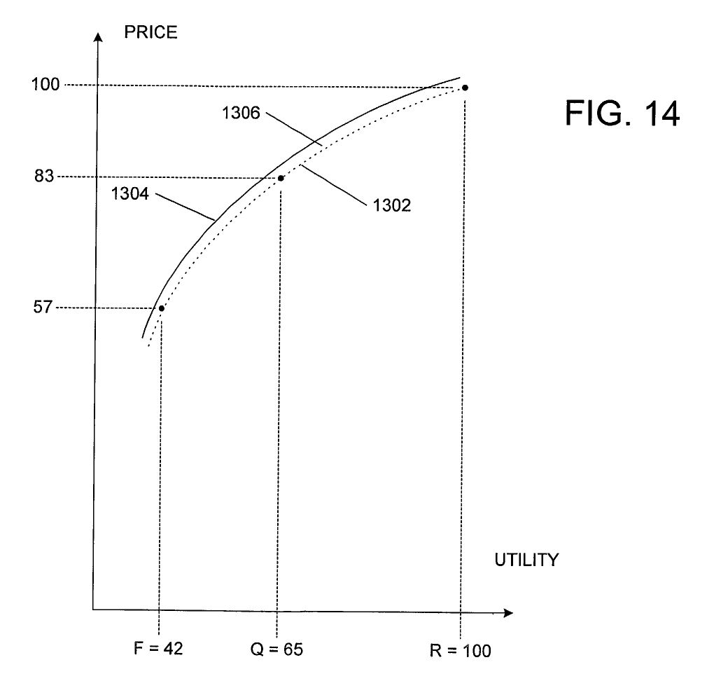

As should be evident from FIG. 13, volume should now be allocated, in whole or part, to item B because it falls below the curve. Of course, since item A is still on the curve, and hence does not represent a bad value for money, the purchaser can maintain volume allocation to item A. FIG. 14 is an example price vs. utility graph. As shown, there are three products F, Q and R whose price and utility points (42, 57), (65, 83) and (100,100) have been normalized to a range between 0 and 100. These points were used to generate a utility curve 1402. Additionally, the purchaser specified an offset value which is used to generate a second curve 1404 offset above the calculated utility curve 1402 by the offset value. The area between the utility curve 1402 and the second curve 1404 is the utility band 1406. Thus, the defined band 1406 can be used to prompt purchaser regarding their allocation(s).

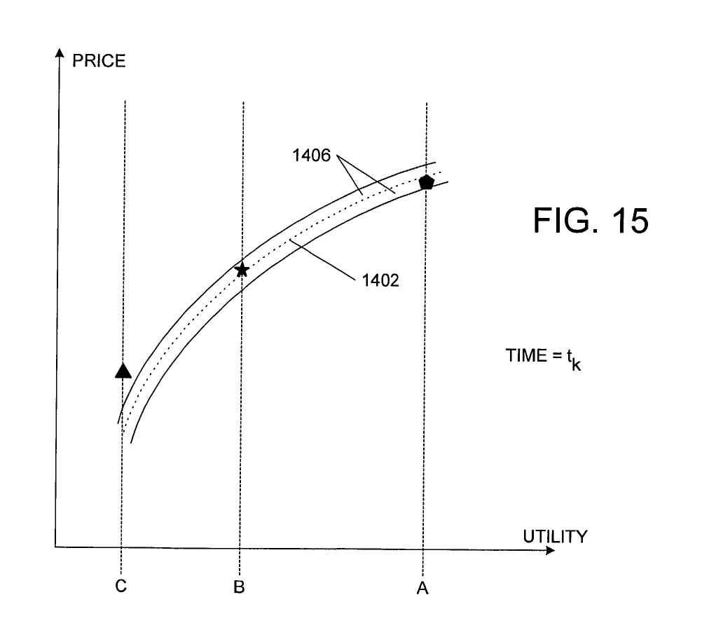

FIG. 15 is an example negotiation at time tₖ. In this negotiation a utility band 1506 is used, the utility band 1506 having been generated by adding and subtracting an offset value to a utility curve 1502. As shown, an allocation could be made to items A and/or B since both fall within the band 1506. Depending upon the specific decision making tool and/or allocation at time tₖ the purchaser could be prompted to shift volume allocation from item B to item A.

As noted above, depending upon the particular implementation options, based upon where items fall relative to the curve or band, the purchaser can be specifically prompted to perform a reallocation, the system can automatically allocate or suggest a specific volume allocation distribution to items A and/or B in FIG. 13 or FIG. 14, or the purchaser can be left to their own choice.

Thus, advantageously, by using a decision making tool, a purchaser is able to make more economically advantageous decisions. Moreover, the decision can be based upon the allocation to the items that best match the utility/price profile of that particular purchaser.

Having shown, by way of several examples, utilization of decision support techniques in accordance with the principles of the invention, it should be understood that several further variants can be implemented. For example, in one variant, suppliers receive feedback regarding the prices offered by one or more of the other suppliers but do not receive feedback as to allocations other than their own. In another variant, suppliers receive feedback regarding allocated quantity to them and one or more of the other suppliers, but only their own pricing. In another variant, a supplier is prompted with a price corresponding to the price which would intersect the current location of the curve. For example, in FIG. 12, the supplier would be prompted to drop the price of item “A” by the difference 1214 or to the curve intersection price 1216. In yet another variant, suppliers see the pricing and quantity allocations for one or more of the other suppliers as well as their own. In still another variant, the utility values and/or prices specified by each purchaser can be averaged on an item-by-item basis. In this variant, the utility function (i.e. price vs. utility curve) can be calculated so that a common utility function can be displayed for all purchasers entitled and/or capable of viewing it.

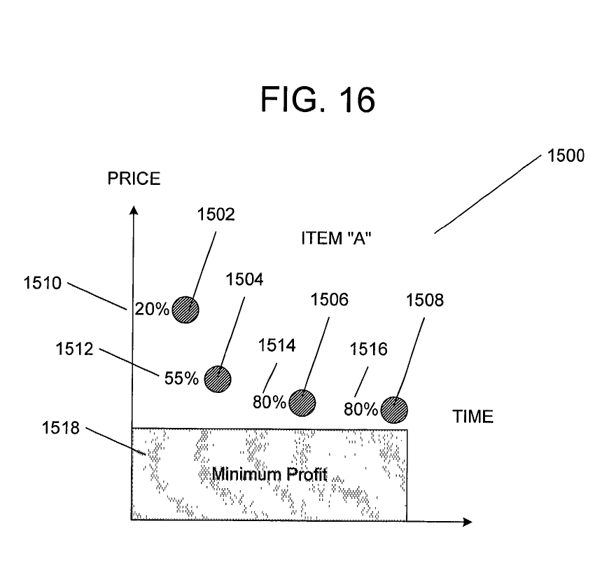

In order to assist suppliers in making pricing decisions, graphical or tabular feedback can also be provided. For example, FIG. 16 shows a representative graphical display 1600 for a decision support tool for a supplier. As shown, the prices 1602, 1604, 1606, 1608 submitted by the supplier over time are plotted with the percentage of the overall volume awarded to them being indicated 1610, 1612, 1614, 1616. Additionally, the supplier can optionally specify a minimum profit or margin, for example as shown in the gray area 1618, as a specific monetary amount, or alternatively, relative to cost, or as a percentage of the selling price. Thus, as shown, this supplier can see that their initial award 1610 was 20% of the overall amount to be awarded. By initially lowering their price 1604, the supplier captured an additional 35% of the volume 1612. Again decreasing the price 1606, by a smaller amount, nevertheless resulted in this supplier capturing a further 25% 1614 of the allocation. At a later time, the supplier slightly decreases the price 1508 however they receive no additional volume allocation 1616. Accordingly, the supplier can decide whether to further decrease the price.

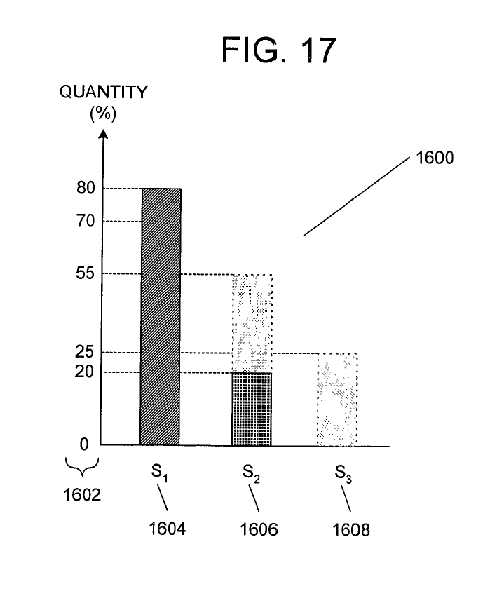

FIG. 17 shows another illustrative variant/alternative graphical display 1700 for supplier usage. As shown, percentage of overall amount to be awarded 1602 is displayed for each supplier 1704, 1706, 1708. In this manner, a supplier can see the effect of their pricing changes relative to allocations to the other suppliers. Thus, even though the supplier who would view the display of FIG. 17 would not know the product or pricing offered by the competing suppliers, the supplier can nevertheless make empirical judgments. For example, assuming supplier S₁ corresponds to the supplier of FIG. 15, Suppliers S₂ and S₃ were respectively allocated 20% and 25% of the total amount to be awarded. After the first re-pricing (when S₁ captured 55% of the allocation) S₂ drops from 55% to 20% and S₃ remains at 25%. On the second re-pricing by S₁, they capture 80%, S₃ loses all allocation and S₂ remains at 20%. On the third re-pricing by S₁, the allocations do not change.

As noted above. and in accordance with the principles of the invention, more complex decision making tools can be employed. A further example variant employing one example complex decision making tool is presented using a three purchaser, three product negotiation.

As discussed above, the purchasers and product details are specified, the purchasers assign weights and utility values using one of the previously described methods, such as utility functions, direct assessment, pair-wise comparison, etc. An overall utility is calculated for each product by each of the purchasers. The status of the process at this point is reflected in Table 9:

TABLE 9

| | Purchaser 1 | Purchaser 2 | Purchaser 3 |
|---|---|---|---|
| A | 90 | 90 | 80 |
| B | 75 | 85 | 30 |
| C | 50 | 60 | 20 |

where the intersection of a row (product) with a column (purchaser) contains the overall utility value relative to that product according to that purchaser.

Each purchaser is then prompted to enter the price differences they are ready to accept for the differences in utility with the product having the highest overall utility value being assigned a default reference of 100. Table 10 illustrates the status of the process at this point.

TABLE 10

| | | |
|---|---|---|
| Purchaser 1 | Purchaser 2 | Purchaser 3 |

| | Utility | Price | Utility | Price | Utility | Price |
|---|---|---|---|---|---|---|
| A | 90 | 100 | 90 | 100 | 80 | 100 |
| B | 75 | | 85 | | 30 | |
| C | 50 | | 60 | | 20 | |

Each purchaser is then prompted to enter the maximum price they would pay for one of the other products if the highest utility product cost 100 units. By way of example, assume that each purchaser provides the values for the products shown in Table 11:

TABLE 11

| | | |
|---|---|---|
| Purchaser 1 | Purchaser 2 | Purchaser 3 |

| | Utility | Price | Utility | Price | Utility | Price |
|---|---|---|---|---|---|---|
| A | 90 | 100 | 90 | 100 | 80 | 100 |
| B | 75 | 77.50 | 85 | | 30 | |
| C | 50 | | 60 | 60 | 20 | 40 |

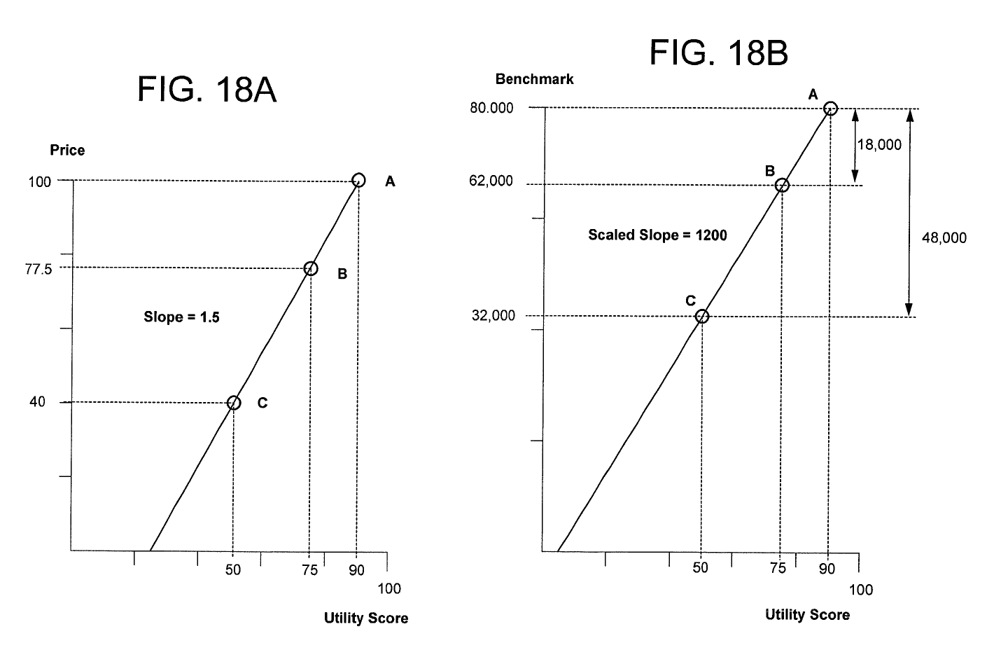

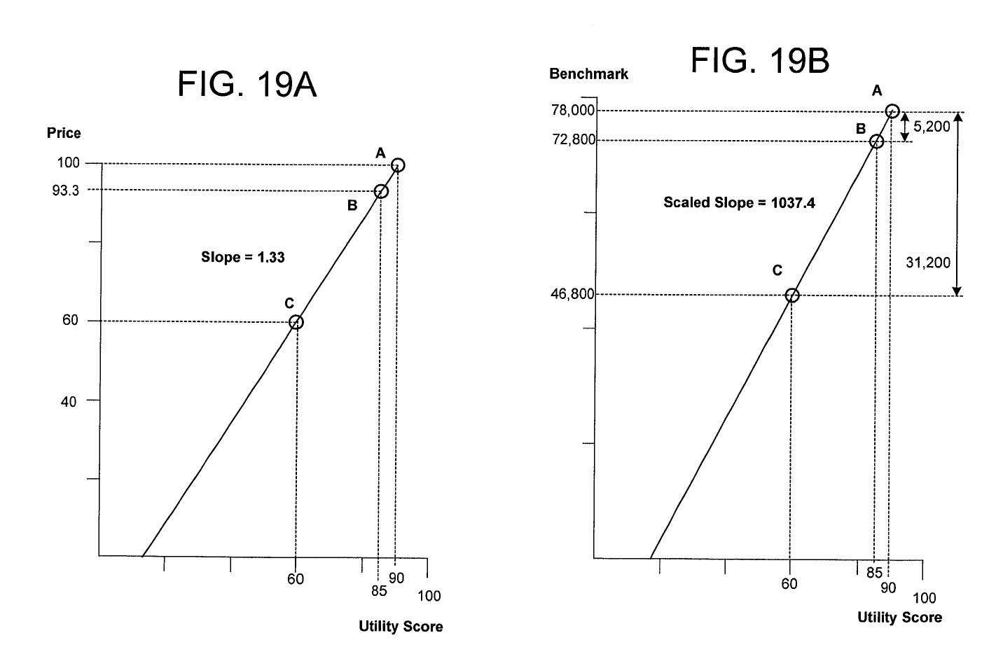

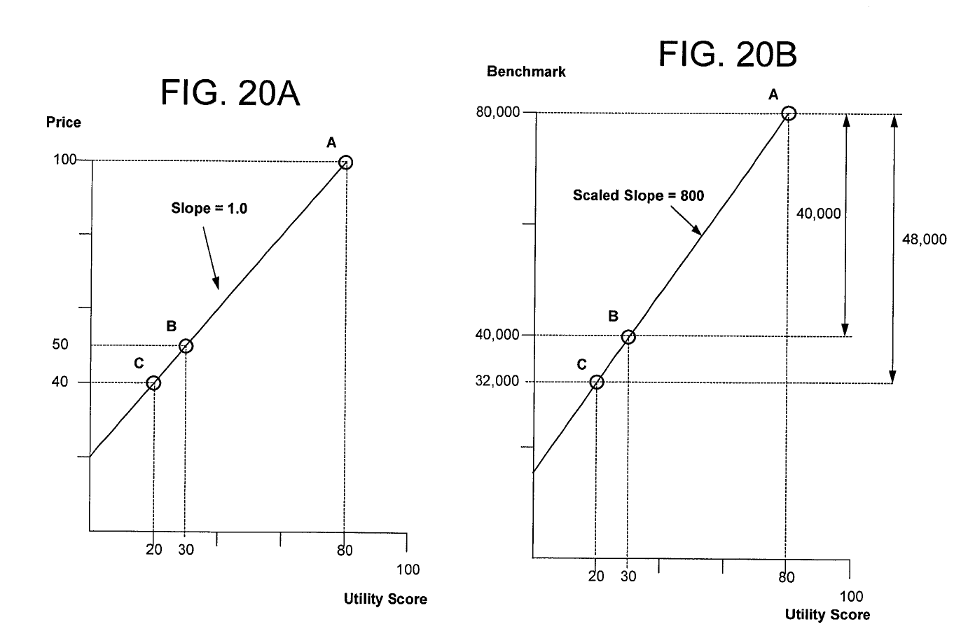

Using a standard linear function and the two price-utility pairs, the system calculates the slope of the line passing through the two price-utility pairs and values for any remaining products for each purchaser based upon the linear function. This is illustrated graphically in FIGS. 18A, 19A and 20A respectively for purchaser 1, purchaser 2 and purchaser 3.

Thus, for the example of Table 10, the result would be as illustrated in Table 12 following the calculation.

TABLE 12

| | | |
|---|---|---|
| Purchaser 1 | Purchaser 2 | Purchaser 3 |
| Slope: 1.50 | Slope 1.33 | Slope 1.00 |

| | Utility | Price | Utility | Price | Utility | Price |
|---|---|---|---|---|---|---|
| A | 90 | 100 | 90 | 100 | 80 | 100 |
| B | 75 | 77.5 | 85 | 93.3 | 30 | 50 |
| C | 50 | 40 | 60 | 60 | 20 | 40 |

The purchasers are also prompted for a benchmark price for one of the products, typically the highest utility product. The benchmark price represents the maximum amount the purchaser would pay for that product. The benchmark price may be based upon the purchaser's experience, prior purchases, expected profit, or on any other basis.

Presume that: Purchaser 1 enters a currency amount of 80,000, Purchaser 2 enters a currency amount of 78,000, and Purchaser 3 enters a currency amount of 80,000, as shown in Table 13.

TABLE 12

| | | |
|---|---|---|
| Purchaser 1 | Purchaser 2 | Purchaser 3 |
| Slope: 1.50 | Slope 1.33 | Slope 1.00 |

| | Utility | Price | Benchmark | Utility | Price | Benchmark | Utility | Price | Benchmark |
|---|---|---|---|---|---|---|---|---|---|
| A | 90 | 100 | 80,000 | 90 | 100 | 78,000 | 80 | 100 | 80,000 |
| B | 75 | 77.5 | | 85 | 93.3 | | 30 | 50 | |
| C | 50 | 40 | | 60 | 60 | | 20 | 40 | |

Once a benchmark amount has been obtained, corresponding prices can be obtained for each of the other products. This may be done in any number of ways including the following two. In one variant, the benchmark price is compared to the corresponding reference price to obtain a pricing factor. For example, in the case of purchasers 1 and 3, their benchmark prices are both 80,000 for a reference price of 100. Thus, the pricing factor is 800 because the benchmark prices are 800 times the reference prices (80,000/100=800). By multiplying the other reference prices by the pricing factor of 800, the corresponding benchmarks for those products can also be obtained.

In a second variant, the benchmark price is compared to the corresponding reference price as with the first variant, but the calculated slope is multiplied (i.e. scaled) by the pricing factor. Thus, for the same examples used above, the slope for purchaser 1 would be 800×1.5=1200, the slope for purchaser 2 would be 780×1.33=1037.4, and the slope for purchaser 3 would be 800×1=800. Using basic algebra, the other benchmark prices can be obtained using the scaled slope and the single benchmark price. FIGS. 18B, 19B and 20B are example benchmark vs. utility graphs respectively for purchaser 1, purchaser 2 and purchaser 3 having a slopes scaled from corresponding FIGS. 18A, 19A and 20A. The values calculated for the products in accordance with either approach are shown in Table 13:

TABLE 13

| | | |
|---|---|---|
| Purchaser 1 | Purchaser 2 | Purchaser 3 |
| Slope: 1.50 | Slope 1.33 | Slope 1.00 |
| Scaled Slope: 1200 | Scaled Slope: 1037.4 | Scaled Slope: 800 |

| | Utility | Price | Benchmark | Utility | Price | Benchmark | Utility | Price | Benchmark |
|---|---|---|---|---|---|---|---|---|---|
| A | 90 | 100 | 80,000 | 90 | 100 | 78,000 | 80 | 100 | 80,000 |
| B | 75 | 77.5 | 62,000 | 85 | 93.3 | 72,800 | 30 | 50 | 40,000 |
| C | 50 | 40 | 32,000 | 60 | 60 | 46,800 | 20 | 40 | 32,000 |

Once the other values have been calculated, by subtracting the calculated price for the lesser utility product(s), the difference (interchangeably called a “trade-off value” or “Δ value” for the product) can be identified. Thus, for purchaser 1, the trade-off value (ΔB value) for product B is (80,000-62,000)=18,000 and the ΔC value is (80,000-32,000)=48,000. Similar values calculated for each of the products are shown in Table 14.

TABLE 14

| | Purchaser 1 | Purchaser 2 | Purchaser 3 |
|---|---|---|---|
| ΔA | 0 | 0 | 0 |
| ΔB | 18,000 | 5,200 | 50,000 |
| ΔC | 48,000 | 31,200 | 60,000 |

The purpose of the trade-off value is to assist in identifying the best value for the money. For example, for Purchaser 1, if product B is priced at 18,000 currency units below product A, product B represents an equivalent value to a purchase of product A. Once product B is priced more than 18,000 currency units below product A, product B represents the better value for the money. If the price differential between product A and product B is less than 18,000 currency units, product A is the better value for the money.

Once these calculations are complete, the negotiation process begins and proceeds as described above. However, as the supplier's enter the bid prices for their products, the trade-off values are taken into account.

Depending upon the particular implementation, this may be done in a number of ways. In the simplest case, the trade-off values are never seen by the purchasers or suppliers. Instead, the system adds the trade-off value to the amount bid for each product, identifies the product with the lowest price, and prompts the purchaser to allocate to that product. Alternatively, the purchaser may be provided with a tabular representation, such as one of the alternatives shown in Tables 15-17.

Assuming that products A, B and C are priced respectively at A=90,000, B=70,000 and C=43,000, each individual purchaser utilizing this decision making tool would be provided with a representation indicating the best buy, based upon the current pricing and their preference.

For example, for Purchaser 1, a display such as Table 15 could be provided in which the price bid by each supplier is provided in one column, the trade-off value prices in another column, and the “Best Buy” indicated in a third column.

TABLE 15

| | |
|---|---|
| Suppliers' | |
| Products | Purchaser 1 |

| | | |
|---|---|---|
| A = 90,000 | 90,000 | |
| B = 70,000 | 88,000 | BEST BUY |
| C = 43,000 | 91,000 | |

An alternative display is shown in Table 16 for Purchaser 2. In this example, the Purchaser is not presented with any trade-off value information, the Purchaser is only presented with a Best Buy indication derived using the trade-off value.

TABLE 16

| Suppliers' | |
|---|---|
| Products | Purchaser 2 |
| A = 90,000 | |
| B = 70,000 | |
| C = 43,000 | BEST BUY |

A further alternative is shown in Table 17, for Purchaser 3, where, instead of including trade-off value price information, a “Comparable” price is calculated by subtracting the trade-off value for the product from the price of the benchmarked (i.e. highest utility value) product. Thus, product B (90,000 [bid for product A]—50,000 [trade-off value for product B]) would have to be priced at 40,000 currency units to be comparable to product A at 90,000 currency units. Similarly, product would have to be priced at 30,000 currency units to be comparable to product A at 90,000 currency units.

TABLE 17

| | |
|---|---|
| Suppliers' | Purchaser 3 |

| Products | Comparable | |
|---|---|---|
| A = 90,000 | 0 | BEST BUY |
| B = 70,000 | 40,000 | |
| C = 43,000 | 30,000 | |

An illustration of all three purchasers and products in a consolidated form according to the format of Table 15, is shown in Table 18:

TABLE 18

| | Purchaser 1 | | Purchaser 2 | | Purchaser 3 | |
|---|---|---|---|---|---|---|
| A = 90,000 | 90,000 | | 90,000 | | 90,000 | Best |
| | | | | | | Buy |
| B = 70,000 | 88,000 | Best | 75,000 | | 120,000 | |
| | | Buy | | | | |
| C = 43,000 | 91,000 | | 74,200 | Best | 103,000 | |
| | | | | Buy | | |

Thus, the best alternatives for each purchaser are, for Purchaser 1—product B; Purchaser 2—product C; and Purchaser 3—product A.

As noted above, the ability to use a decision making tool is not limited to purchasers. In a further variant, suppliers can also, or alternatively, make use of a supplier-side version of the immediately preceding decision making tool. As noted above, each of the suppliers, to whom a the decision making tool is available, will receive price recommendations based upon the information provided by the purchasers in accordance with the particular system implementation. Those recommendations will show, for example, any product that has been recommended to a purchaser as a best buy. In other implementations, suppliers can be further prompted as to how they can optimize their volume in units, their sales in value, or their margins.

A further example supplier-side decision making tool is presented with continuing reference to the immediately preceding purchaser decision making tool. As above, in this example, initially, the supplier for product A has submitted his initial price of 90.000, supplier for product B has submitted an initial price of 70,000 and the supplier for product C has submitted an initial price of 43,000. In this example, based upon the purchaser-side calculations noted above, the supplier for product A receives an indication that they are a recommended best buy to purchaser 3.

Advantageously, in some variants, the supplier can also be prompted as to the price at which the offered product would be a recommended Best Buy for one or more of the other purchasers. Thus, in the above case, the supplier can be prompted textually, graphically, in tabular, or some other manner, for example, as shown in Table 19.

TABLE 19

| | Price Recommendation for “Best Buy” Status | | |
|---|---|---|---|
| Price(s) Submitted | Purchaser 1 | Purchaser 2 | Purchaser 3 |
| A = 90,000 | 88,000 | 74,200 | Best Buy |

In this case, all other supplier prices being unchanged, if the supplier of product A dropped the price from 90,000 to 88,000 or less, that supplier would at least be a Best Buy for both purchasers 1 and 3. If the price was dropped to 74,200 or less, product A would be a Best Buy for all three purchasers.

Of course, depending upon the particular product, it may be disadvantageous to drop the price to capture a Best Buy recommendation for all three due, for example, to product cost, minimum profit margins, or other factors. For example, if the cost of product a was 74,000 and the supplier required a minimum profit margin of 10% (i.e. a sales price minimum of 81,400), the supplier could only capture Best Buy recommendations for two of the three purchasers. Thus, through use of a decision making tool as described herein, the supplier is in a better position to evaluate whether a reduction in price is warranted in the negotiation, if at all.

Although the above has been described with respect to a single supplier and product in a relatively static situation, in reality, the situation will be dynamic such that as the negotiation progresses and prices change, so may the Best Buy indications.

In still other variants, in addition to or instead of a Best Buy prompting, suppliers can be prompted as to how to optimize their sales in terms of unit volume, overall revenues and/or margins, alone or in some combination with each other, for example, as part of a tradeoff analysis.

These optimization decision making tools are presented, by way of example, with continuing reference to the preceding simplified examples.

For the optimization variants, presume that each of the purchasers has specified purchase volumes as shown in Table 20.

TABLE 20

| Purchaser | Units to be Purchased |
|---|---|
| 1 | 30 |
| 2 | 20 |
| 3 | 5 |

In order for the system to provide the recommendation(s), each relevant supplier is prompted for the cost of each product tendered. Thus, for purposes of the example, presume that each of the three suppliers provide the cost information for their respective products as shown in Table 21.

TABLE 21

| Product | Cost |
|---|---|
| A | 74,000 |
| B | 32,000 |
| C | 25,000 |

Further, from the above, presume that the supplier of product A has submitted a price of 90,000 and, based upon the Best Buy recommendation to purchaser 3, they have been awarded purchaser 3's entire volume of 5 units.

Using the price, cost and award volume information, the system calculates the sales revenue (price×units awarded), profit ([price−cost]/units awarded), and profit margin (total profit/total sales value). These values are shown in Table 22.

TABLE 22

| | |
|---|---|
| Last Price Submitted | 90,000 |
| Unit Volume Awarded | 5 |
| Sales Revenue | 450,000 |
| Profit | 80,000 |
| Profit Margin | 17.8% |

The system also calculates similar figures for each of the Best Buy prices as alternatives. In this case, using the simplified situation where the suppliers of products B and C maintain their initial price, the system calculates two additional alternatives based upon a price reduction to the prices where product A would be a Best Buy for two and all three purchasers along with the variation from the current status. The result is shown in Table 23.

TABLE 23

| | Present | Variation | X | Variation | Y | Variation |
|---|---|---|---|---|---|---|
| Recommended Price | 90,000 | 0% | 88,000 | −2.22% | 74,200 | −20% |
| Max Potential Volume | 5 | 0% | 35 | | 55 | |
| Max Potential Sales Revenue | 450,000 | 0% | 3,080,000 | 584.4% | 4,081,000 | 806.9% |
| Max Potential Profit | 80,000 | 0% | 490,000 | 512.5% | 11,000 | −86.3% |
| Max Potential Profit Margin | 17.8% | | 15.9% | | 0.3% | |

Thus, the system can now prompt the supplier based upon whether the supplier wants to optimize: total unit volume, overall sales revenue, overall profit, or profit margin. For example, based upon the calculated figures shown in Table 23, when compared with the present status, alternative Y offers the highest potential unit volume (55 units). Thus, if the supplier is interested in maximizing total unit volume the system will recommend that the supplier of product A drop the price to 74,200.

If optimization of sales revenue is desired, when compared with the present status, alternative Y offers the highest potential sales revenue (4,081,000). Thus, the system will recommend supplier A to drop his price to 74,200.

If optimization of overall profit is desired, when compared with the present status, alternative X offers the highest potential overall profit (490,000). Thus, if the supplier is interested in maximizing total profit, the system will recommend that the supplier of product A drop the price to 88,000.

If optimization of profit margin is desired, relative to the present status, the present status offers the highest potential profit margin (17.8%). Thus, if the supplier is interested in maximizing profit margin, the system will recommend that the supplier of product A maintain the present price.

It should be understood that, if a particular supplier offers two or more products, by employing a similar methodology the system can provide optimization recommendations for different product mixes. Moreover, it should be understood that because the system is dealing with semi-fungible goods, purchasers may not exactly follow Best Buy recommendations. Thus, for example, in some cases for some semi-fungible products, at 90,000 or even a price of 88,300, the supplier of product A might nevertheless capture some portion of purchaser 1's overall volume, due to purchaser 1's particular needs (or even a few of purchaser 2's volume). Advantageously, the calculations are dynamic so that the system will respond to updates in allocations or price changes so that a supplier can ascertain their present status and position in the negotiation.

Depending upon the implementation, this cost information and/or calculation results can be stored in the system itself or on the supplier's machine in an applet or “cookie”. The former option allows for faster calculation by the system and reduces the interaction between supplier and system computers, the latter option provides a greater measure of security because potentially sensitive supplier information is not stored in the system where the risk of access by unauthorized third parties is higher.

### Rights Tender Variant Example

In order to ensure further understanding of the principles of the invention in connection with a variant involving tender of rights (and/or rights to exploit), a representative example of a hypothetical negotiation in a further example implementation will now be provided. As with all the examples provided herein, this example is provided to further an understanding of the principles of the invention as they can be applied in one or more implementations employing one or more of the variants described herein.

In this example, presume that a hospital wants to put up for negotiation the management (e.g. exploitation) rights for three parking lots around its buildings. Each lot has its own unique characteristics and Since a hospital operates 24 hours/day, 7 days per week one or more of the lots must be operating at all times. Moreover, the further physically removed a lot is from the hospital and/or the less a lot is used on off hours, the greater the need for a higher level of security. Thus, the hospital is the seller of the rights and those offering the services are the purchasers of those exploitation rights.

In awarding contracts for the lots the hospital wants take into account which service supplier (i.e. exploiter) will provide the best combination of particular levels of surveillance services and income from collection of parking fees. In other words, a supplier offering a higher level of surveillance, for example, through installation and usage of cameras could offer a lower percentage of parking fees collected.

By assigning monetary values to the particular surveillance levels offered and adding them to the corresponding offered income from parking fee collection the overall value of each offer can be calculated.

Thus, the hospital will award the contract, for a given lot or group of lots, to the service supplier with the highest overall value to the hospital. In other words, the service supplier having the best offer in terms of price (i.e. service value) vs utility for a lot will be awarded the contract.

Proceeding with the example, the hospital has three parking lots known as Lot 1, Lot 2 and Lot 3. Lot 1 is the closest to the hospital and located on the grounds immediately next to the emergency room entrance. There is continual activity in the area, so security is of minimal importance and fee related service is of paramount importance. Lot 2 is the furthest from the hospital and is alongside a large storage warehouse in a lightly trafficked industrial area. The bulk of the lot is not visible to anyone not physically inside the lot. Moreover, on occasion, there have been instances of where people have been interfered with, vehicles have been vandalized and, in some cases, stolen from the lot. Thus, for this lot, security is of paramount importance. Lot 3 is further from the hospital than Lot 1 but in an area that is reasonably well traveled, albeit less so during the night than during the day. Accordingly, the hospital's needs are for some intermediate combination of security and fee related service.

There are three prospective suppliers: Watch Dogs, Park & Son and Crooks, Inc.

In the prior year each lot was subject to a management contract. According to those contracts, Lot 1 was managed by Watch Dogs and the service was of a minimum level valued at 20,000. Lot 2 was also managed by Watch Dogs and had an average to higher level of service valued at 15.000. Lot 3 was managed by Park & Son at an average level of service valued at 8.500.

Since the system implementation being used in this example incorporates a decision making tool option, that tool is used herein. Of course, other variants may use a different tool or not use any decision making tool at all.

The hospital specifies a set of evaluation criteria which identify the different needs to be taken into account for each of the lots. Ideally, the hospital would like to maximize satisfaction of those needs as well as fees received. However, the hospital is willing to accept a tradeoff in terms of lower revenue from fees in return for higher levels of service, but only to the point it considers such levels of value. For example, the hospital might be willing to give up some fees to ensure a heavily trafficked lot only open during normal business hours has controlled access, but might not be willing to forego additional fees for the additional provision of an armed guard to patrol that lot. While such a case would provide additional security, the hospital would likely consider it of no additional value and hence be unwilling to give up any additional fees to have that level of service for that lot.

Depending upon the particular implementation, these criteria and/or certain sub-criteria are each represented by an evaluation measure that is binary (e.g. must have or do not have to have), linear (also called “relative”)(e.g. on a scale of 0 to 100, if criterion T was rated a 100 what would you rate criterion H?), or direct (e.g. on a scale of 0 to 100, individually rate criteria A through F.

Assume that the hospital specified criteria are Security, Convenience and Parking Rate Charges, each being subject to a relative evaluation criterion. Moreover, the Security criterion has two sub criteria to be used to analyze the supplier offering: Video Camera(s) and 24 hr/7 day Guard, each being subject to a binary evaluation criterion (provided or not provided). The convenience criterion has three sub-criteria to be used to analyze the supplier offering: change machine on premises, live cashier, and emergency phone box in lot. Each of these is similarly subject to a binary evaluation criterion. The final criterion, Parking Rate Charges also has two evaluation criteria to be used to analyze the supplier offering: flat fee if parked for more than 8 hours and free parking for hospital employees, each of which is subject to a binary evaluation criterion (i.e. yes or no).

As a prelude to the negotiation, the hospital is prompted as follows to provide information to be used for each lot:

On a scale of 0 to 100, if Security is a “100” what value do you place on each of Convenience and Parking Rate Charges? In response, the hospital provides the information shown in Table 24 as the “Input” value. From those values the “Relative Value” as a percent of the whole (in this case 100+60+40 or 200).

TABLE 24

| | Criterion | Input | Relative Value |
|---|---|---|---|
| Security | | 100 | 50% |
| Video Camera | Binary | | |
| 24/7 Guard | Binary | | |
| Convenience | | 60 | 30% |
| Live Cashier | Binary | | |
| Change Machine | Binary | | |
| Emergency Phone | Binary | | |
| Parking Rate Charges | | 40 | 20% |
| 8+hr Flat Fee | Binary | | |
| Employees Free | Binary | | |

Within each criterion, similar prompting is done for the sub-criteria except that, in this case, the sub criteria for Security and Parking Rate Charges are direct and the sub criteria for Convenience are linear. At this point, the hospital decides that the Emergency Phone criterion is no longer important. As a result, that criterion is deleted. After appropriate prompting, the hospital's inputs are as shown in Table 25.

TABLE 25

| | Criterion to Supplier | Input | Relative Value |
|---|---|---|---|
| Security | | 100 | 50% |
| Video Camera | Binary | 70 | 35% |
| 24/7 Guard | Binary | 30 | 15% |
| Convenience | | 60 | 30% |
| Live Cashier | Binary | 100 | 25% |
| Change Machine | Binary | 20 | 5% |
| Parking Rate Charges | | 40 | 20% |
| 8+hr Flat Fee | Binary | 60 | 10% |
| Employees Free | Binary | 60 | 10% |

The process is repeated for each of the remaining two lots. Those sub criteria are then used to prompt each supplier relative to their offering. For example, Watch Dogs is prompted for each lot and provides the results shown in Table 26.

TABLE 26

| | | Input | Utility | Input | Utility | Input | Utility |
|---|---|---|---|---|---|---|---|
| Watch Dogs | Criterion | Lot 1 | Value | Lot 2 | Value | Lot 3 | Value |
| Security | | | | | | | |
| Video Camera | Binary | No | | No | | Yes | |
| 24/7 Guard | Binary | Yes | | Yes | | No | |
| Convenience | | | | | | | |
| Live Cashier | Binary | No | | Yes | | Yes | |
| Change Machine | Binary | Yes | | Yes | | No | |
| Parking Rate Charges | | | | | | | |
| 8+ hr Flat Fee | Binary | Yes | | No | | Yes | |
| Employees Free | Binary | No | | No | | Yes | |
| Total Utility | | | | | | | |

The Utility Value for each sub criterion is then taken as the Relative Value for each “Yes”. The total or overall service supplier utility value for each lot is the sum of the individual utility values as shown in Table 27.

TABLE 27

| | | Input | Utility | Input | Utility | Input | Utility |
|---|---|---|---|---|---|---|---|
| Watch Dogs | Criterion | Lot 1 | Value | Lot 2 | Value | Lot 3 | Value |
| Security | | | | | | | |
| Video Camera | Binary | No | | No | | Yes | 35 |
| 24/7 Guard | Binary | Yes | 15 | Yes | 15 | No | |
| Convenience | | | | | | | |
| Live Cashier | Binary | No | | Yes | 25 | Yes | 25 |
| Change Machine | Binary | Yes | 5 | Yes | 5 | No | |
| Parking Rate Charges | | | | | | | |
| 8+ hr Flat Fee | Binary | Yes | 10 | No | | Yes | 10 |
| Employees Free | Binary | No | | No | | Yes | 10 |
| Total Utility | | | 30 | | 45 | | 80 |

The same is done for each of the other service suppliers. Presuming that the others have complied, Table 28 represents a compilation of example results for each of the potential exploiters.

TABLE 28

| | Lot 1 | Lot 2 | Lot 3 |
|---|---|---|---|
| Watch Dogs | 30% | 45% | 80% |
| Park & Son | 55% | 40% | 50% |
| Crooks Inc. | 75% | 65% | 35% |

The prior year's contract values are then used as benchmarks in conjunction with the utility values of Table 28 to obtain a slope as follows. First, the system assigns a Reference Price of 100 to the lowest utility value for each lot as shown in Table 29.

TABLE 29

| | Lot 1 | Ref Price | Lot 2 | Ref Price | Lot 3 | Ref Price |
|---|---|---|---|---|---|---|
| Watch Dogs | 30% | 100 | 45% | | 80% | |
| Park & Son | 55% | | 40% | 100 | 50% | |
| Crooks Inc. | 75% | | 65% | | 35% | 100 |

The hospital is then asked, for each lot, “If the value of management incorporating a minimum level of security related service is 100, how much would you be willing to give up to receive the highest level of security service for this lot?”

In this example, Lot 1 causes the least concern in terms of security but has the greatest concern in terms of fee related service. As a result, the hospital enters a value of 85, since it does not place much value higher security for the lot. For Lot 2 however, security is of significant concern, so the hospital enters a value of 50. For Lot 3, the hospital enters a value of 55. Using these numbers, the system calculates the slope (for services it will be negative since prices go up during the negotiation). Thus, after calculation, the slope for Lot 1 is −0.3333, Lot 2 is −2.0, and Lot 3 is −1.0. The results are shown, in summary, in Table 30.

TABLE 30

| | Lot 1 | Ref Price | Lot 2 | Ref Price | Lot 3 | Ref Price |
|---|---|---|---|---|---|---|
| Watch Dogs | 30% | 100 | 45% | 90 | 80% | 55 |
| Park & Son | 55% | 92 | 40% | 100 | 50% | 85 |
| Crooks Inc. | 75% | 85 | 65% | 50 | 35% | 100 |

| | | | |
|---|---|---|---|
| Slope | −0.3333333 | −2 | −1 |

Once calculation of the slopes (and/or the other reference price(s)) is complete, each prior actual contract price is used as the benchmark for that entity. Of course, this presumes that the prior managing (i.e. service supplier) entities are in the negotiation. If one or more prior service supplier entity(ies) are not in the negotiation, the prior value can still be used but it should be correlated to the closest comparable level of service and an empirical adjustment should (but need not necessarily) be made to take into account any meaningful differences.

Applying the benchmark prices and using the slopes to ascertain benchmarks for the other service suppliers as described herein yields the results of Table 31.

TABLE 31

| | | |
|---|---|---|
| Lot 1 | Lot 2 | Lot 3 |

| | Utility | Ref. | | Utility | Ref. | | Utility | Ref. | |
|---|---|---|---|---|---|---|---|---|---|
| | Value | Price | Bench | Value | Price | Bench | Value | Price | Bench |
| Watch Dogs | 30% | 100 | 20,000 | 45% | 90 | 15,000 | 80% | 55 | 5,500 |
| Park & Son | 55% | 92 | 18,400 | 40% | 100 | 16,666 | 50% | 85 | 8,500 |
| Crooks Inc. | 75% | 85 | 17,000 | 65% | 50 | 8,333 | 35% | 100 | 10,000 |

| | | |
|---|---|---|
| −0.33333333 | −2 | −1 |

Once the benchmark values are calculated, the trade-off values are obtained by obtaining the difference between the reference 100 benchmark price and the other prices. Since the value of the services go up as the negotiation progresses, in this example case they will be added to the submission to identify a “best value” or “best buy”. The trade-off value results are summarized in Table 32.

TABLE 32

| | Lot 1 | Lot 2 | Lot 3 |
|---|---|---|---|
| Watch Dogs | — | 1,667 | 4,600 |
| Park & Son | 1,600 | — | 1,500 |
| Crooks Inc. | 3,000 | 8,333 | — |

At this point, the negotiation is ready to proceed.

Presume that each service supplier submits values for the services for each lot as follows.

TABLE 33

| | Lot 1 | Lot 2 | Lot 3 |
|---|---|---|---|
| Watch Dogs | 21,000 | 16,000 | 5,500 |
| Park & Son | 18,000 | 15,000 | 10,000 |
| Crooks Inc. | 16,000 | 9,000 | 7,000 |

Using the trade-off values and the initial exploiter value submissions, the “Best Value” is identified (Tables 34-36) and the hospital is informed.

TABLE 34
LOT 1

| | Supplier Bid | Trade off | Total | |
|---|---|---|---|---|
| Watch Dogs | 21,000 | — | 21,000 | BEST |
| Park & Son | 18,000 | 1,600 | 19,600 | |
| Crooks Inc. | 16,000 | 3,000 | 19,000 | |

TABLE 35
LOT 2

| | Supplier Bid | Trade off | Total | |
|---|---|---|---|---|
| Watch Dogs | 16,000 | 1,667 | 17,667 | BEST |
| Park & Son | 15,000 | — | 15,000 | |
| Crooks Inc. | 9,000 | 8,333 | 17,333 | |

TABLE 36
LOT 3

| | Supplier Bid | Trade off | Total | |
|---|---|---|---|---|
| Watch Dogs | 5,500 | 4,500 | 10,000 | |
| Park & Son | 10,000 | 1,500 | 11,500 | BEST |
| Crooks Inc. | 7,000 | — | 7,000 | |

As an initial matter, an initial negotiation award is made to the entities having the identified best values.

In a similar vein, presuming that the system is a variant that supports supplier prompting, the service suppliers are also prompted, using the trade-off values, so that they can consider whether they want to try and capture a contract award for any other lot. Thus, in this variant, each receives an indication of their bid, whether that bid resulted in an award, and a recommendation as to the value necessary to obtain an award for any lot they did not presently have awarded to them.

For example, based upon the initial values, Watch Dogs receives the information in Table 37.

TABLE 37

| Watch Dogs | Value | Awarded | Recommendation |
|---|---|---|---|
| Lot 1 | 21,000 | YES | 21,000 |
| Lot 2 | 16,000 | YES | 16,000 |
| Lot 3 | 5,500 | NO | 7,000 |

Park & Son receives the information in Table 38.

TABLE 38

| Park & Son | Value | Awarded | Recommendation |
|---|---|---|---|
| Lot 1 | 18,000 | NO | 19,400 |
| Lot 2 | 15,000 | NO | 17,667 |
| Lot 3 | 10,000 | YES | 10,000 |

Crooks Inc. receives the information in Table 39.

TABLE 39

| Crooks Inc | Value | Awarded | Recommendation |
|---|---|---|---|
| Lot 1 | 21,000 | NO | 18,000 |
| Lot 2 | 16,000 | NO | 9,333 |
| Lot 3 | 5,500 | NO | 11,500 |

In a second round, Watch Dogs changes their submission for Lot 3 to 8,000, Park & Son changes their submission for Lot 1 to 19,500 and for Lot 2 to 17,500. Crooks Inc. changes their submission for Lot 1 to 18,000 and for Lot 2 to 9,335.

Using the trade-off values again and the new supplier submissions, the “Best Values” are again identified (Tables 40-42) and the hospital is informed.

TABLE 40

| LOT 1 | Supplier Bid | Trade off | Total | |
|---|---|---|---|---|
| Watch Dogs | 21,000 | — | 21,000 | |
| Park & Son | 19,500 | 1,600 | 21,100 | BEST |
| Crooks Inc. | 18,000 | 3,000 | 21,000 | |

TABLE 41

| Lot 2 | Supplier Bid | Trade off | Total | |
|---|---|---|---|---|
| Watch Dogs | 16,000 | 1,667 | 17,667 | |
| Park & Son | 17,500 | — | 17,500 | BEST |
| Crooks Inc. | 9,335 | 8,333 | 17,668 | |

TABLE 42

| Lot 3 | Supplier Bid | Trade off | Total | |
|---|---|---|---|---|
| Watch Dogs | 8,000 | 4,500 | 12,500 | BEST |
| Park & Son | 10,000 | 1,500 | 11,500 | |
| Crooks Inc. | 7,000 | — | 7,000 | |

Based upon the new values, Watch Dogs receives the information in Table 43.

TABLE 43

| Watch Dogs | Value | Awarded | Recommendation |
|---|---|---|---|
| Lot 1 | 21,000 | NO | 21,100 |
| Lot 2 | 16,000 | NO | 16,002 |
| Lot 3 | 8,000 | YES | 8,000 |

Park & Son receives the information in Table 44.

TABLE 44

| Park & Son | Value | Awarded | Recommendation |
|---|---|---|---|
| Lot 1 | 19,500 | YES | 19,500 |
| Lot 2 | 17,500 | NO | 17,668 |
| Lot 3 | 10,000 | NO | 11,000 |

Crooks Inc. receives the information in Table 45.

TABLE 45

| Crooks Inc | Value | Awarded | Recommendation |
|---|---|---|---|
| Lot 1 | 18,000 | NO | 18,100 |
| Lot 2 | 9,335 | YES | 9,335 |
| Lot 3 | 7,000 | NO | 12,500 |

The process thereafter repeats until either time runs out or there is no activity for a specified amount of time.

In practice, it should be recognized that management of parking lots is semi-fungible in nature. Nevertheless, by applying the principles of the invention the lots of the hospital can be aggregated with parking lots of other entities requiring parking lot management services.

For purposes of understanding, however, a description relative to a single hospital has been provided for simplicity. The negotiation in aggregate would proceed in similar fashion except that the prospective exploiters would see a combined result instead of just the results for the hospital in the example.

Additionally, for any such negotiation, the variants described in connection with the product related negotiation can also be employed through straightforward modification to take into account that as the negotiation progresses bids go up instead of down.

It will now be understood that all the examples herein can be generically classified as either:

i) “One-to-Many” with one buyer and at least two tendered semi-fungible products, services or rights; or

ii) “Many-to-Many” with at least two buyers and at least two semi-fungible products, services or rights, whether or not optionally including utility adjusted pricing, differing levels of information availability and/or prompting to maximize or optimize value for money, volumes, sales and/or profits.

### Multinational Features

In some cases, the products required or being bid transcend national boundaries, for example, because the purchaser has multinational operations or foreign suppliers wish to bid their products. Because some implementations include an internet accessible interface, any entity in the world capable of connecting to the internet and being qualified as a purchaser or supplier can potentially participate in the negotiation, subject of course to compliance with local and/or national laws, ordinances or contractual constraints or requirements. Advantageously, such implementations can facilitate increased competition thereby improving market efficiency and reducing costs.

In one such implementation, when a participant logs on to a negotiation, the participant is prompted to select a negotiation currency. Once they have done so, they can enter amounts in the specified currency—even if no other participant is operating in that currency. The system includes a currency conversion calculator which allows immediate conversion of the entered currency into any other major currency. This conversion is facilitated by the ready availability of current exchange rates for most major currencies at numerous sites on the internet. This allows bidders to bid in a currency they are familiar and comfortable with, as opposed to the currency dictated by another party. Thus, for example, if all the purchasers of products are in the United States and one of the suppliers is in England and another in Germany, the English bidder could bid in Pounds and the German could bid in either Deutschmarks or Euros. In any of those cases, the product purchaser's screens would reflect the bids in U.S. Dollars. In another example, a multinational company that manufactures the same product class or type in several countries can bid based upon the most advantageous location at the time. Thus, if a company has manufacturing in Ireland and China and the Irish factory has excess capacity while the Chinese factory is at capacity or experiencing problems, bids entered can take the Irish origin into account even if, as a matter of cost, shipping the product from Ireland would be more expensive.

In another implementation, when a participant (typically a purchaser) logs on to initiate a negotiation, the participant can be prompted to select a negotiation currency. Once they have done so, all participants must enter amounts in that specified currency. In this way, participants can ensure that bids are provided in a currency that is stable and/or they are comfortable with.

Of course, it will be recognized that the system implementation can also dictate the currency to be used, thereby simplifying the implementation.

It should be understood in all implementations involving decision support tools, the particular tool, its availability to one or more of the participants, and the information or its form provided to any particular participant may differ. Moreover, in some cases, the particulars of the negotiation may be such that a particular decision support tool is inadequate or the use of any decision support tool is unnecessary even if it is available, for example, where two or more items have identical utility to a specific purchaser such that price is the only distinguishing factor among them. Additionally, it should be understood that the type of feedback (i.e. graphical, tabular and/or purely numerical/textual) may vary from implementation to implementation or, for some implementations, from negotiation to negotiation without departing from the principles of the invention. Finally, it should be understood that the level of “blindness” employed is, as a general matter, independent of the type and kind of decision support tool (if any) that is available and vice versa. Nevertheless, in some cases, a particular level of blindness may be compromised or wholly incompatible with some particular decision support implementation.

Additionally, and advantageously, the specifics of negotiations can be tracked within the system on an item, category, supplier, purchaser and or negotiation basis. That information can be stored for analysis and retrieval so that, in further variants and implementations, artificial intelligence techniques can be used. In this manner, information from other negotiations can assist in providing prompts, analyzing purchaser and/or supplier behaviors and predicting future behaviors.

Although the above examples were described in connection with the internet, it will be recognized that through straightforward use of known voice response, voice recognition and/or computer generated voice techniques, as well as touch-tone recognition and two-way paging technology, implementations can be constructed which enable one or more participants to participate in the negotiation using a limited graphics capable communication device such as a cellular telephone or non-graphical conventional telephone. Similarly, using known conversion techniques, devices with limited display capability, such as digital pagers or cellular phones with multi-line displays can also be used. Of course, in both cases, the information received may be less than what would be available in the same negotiation to the same participant using a device with a full graphical display.

### Commercially Suitable Example

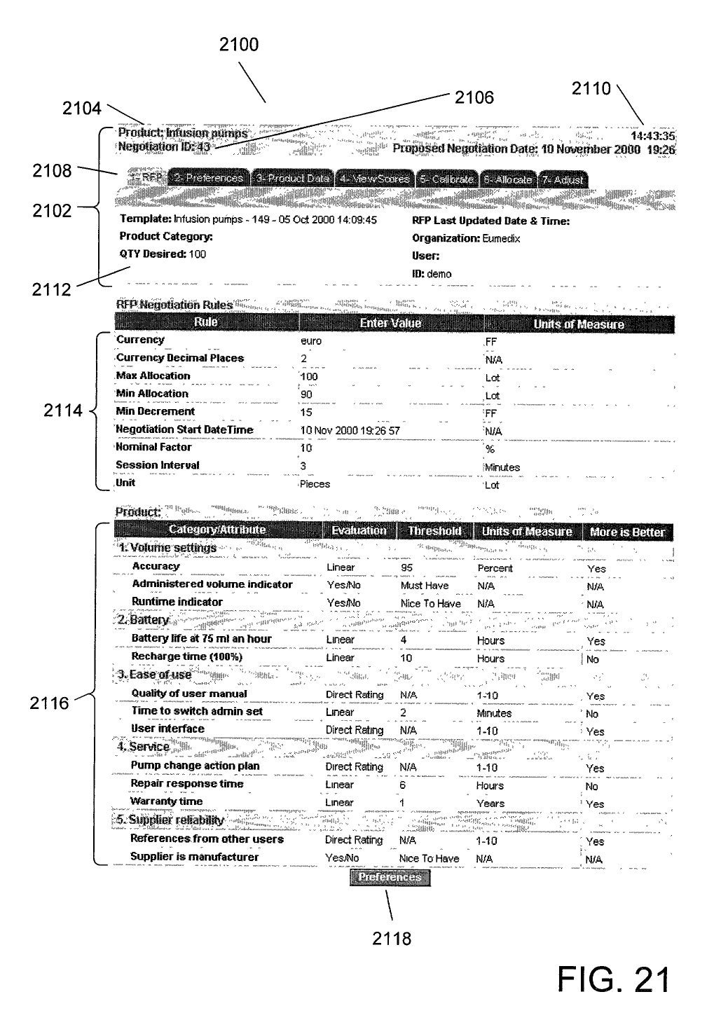

FIGS. 21 through 28 are a series of hypothetical example screens which collectively illustrate different aspects of a commercially suitable system incorporating teachings contained herein. Moreover, as will be evident from some of the screens, the system further incorporates some of the options described herein.

It should be understood however, that the example system is merely provided for purposes of further illustration and is intended to suggest some further variants and ways the invention may be advantageously used. It is not intended to otherwise limit the invention either by what is shown or by what has been omitted.

Referring now to FIG. 21, which is an example RFP screen 2100 to be used by a purchaser in a product-based negotiation. The RFP screen is used to collect information about what the purchaser needs and deems important. The screen includes a header 2102 that contains basic information regarding the negotiation to which the screen pertains.

As shown, the product 2104 that will be the subject of the negotiation is Infusion Pumps. The negotiation has been assigned an identifier 2106 of “43”. The proposed negotiation start 9908 is “Nov. 10, 2000” at “19:26” and a current time clock 2110 illustratively showing “14:43:35”. The screen also includes a series of tabs that can be used to switch to the other screens of FIGS. 21 through 28. Additionally, the header 2102 includes more specific negotiation related information 2112, for example, an identification of the particular template to be used in gathering information for the negotiation, a product category, for example medical devices, pharmaceuticals, building supplies, plumbing fixtures, etc., the “quantity desired” (i.e. current needs quantity), an indication of when the RFP was updated last, the purchaser's company or organization, the specific user and a user id.

The screen 2100 further includes a set of negotiation 2114 rules that will apply to the negotiation. As shown, the rules 2114 specify that the currency to be used is a European currency, specifically “FF” (for French Francs), and currency calculations will be rounded to two decimal places. The rules 2114 further specify that the maximum allocation is 100 lots, the minimum amount to be purchased is 90 lots, and that prices must be adjusted by at least 15FF at a time. The negotiation start date and time is also specified. The nominal factor indicates the percentage that will be added to, and subtracted from, any parameter range in a calculation such as described in connection with FIG. 11. The session interval is the amount of time a supplier or purchaser will have to, respectively, modify their price or allocation. The “Unit” rule specifies that, for purposes of negotiation, one “piece” refers to one lot.

Beneath the rules 2114 is a section 2116 related to product specific attributes or criteria. In this example, the particular criteria are “Volume Settings”, “Battery”, “Ease of Use”, “Service” and “Supplier Reliability”. Each of these criteria have two or three sub-criteria. Each sub-criterion is specified in terms of an evaluation measure (i.e. binary (e.g. Yes/No), linear or direct). Additionally, not only do the linear measure criteria include a threshold, but the binary criteria have thresholds as well. In this example, the “Must Have” threshold can be used to disqualify a particular supplier product, whereas a “Nice To Have” threshold will not necessarily result in disqualification of a non-compliant supplier product. The “Units of Measure” is self explanatory and the “More is Better” indicates for the linear and direct evaluation measures whether the purchaser places any value on a product with superior performance in that sub-criterion. For example, with respect to the police vehicle example discussed above, if a sub-criterion was a 40 liter gas tank and the cars rarely burned more that 30 liters between fill-ups, it is unlikely that a the purchaser would specify “Yes” for that criterion under “More is Better”. Whereas, if the sub-criterion was at least 5,600 km between oil changes, they may well place a higher value on the amount that a vehicle offering exceeds that amount.

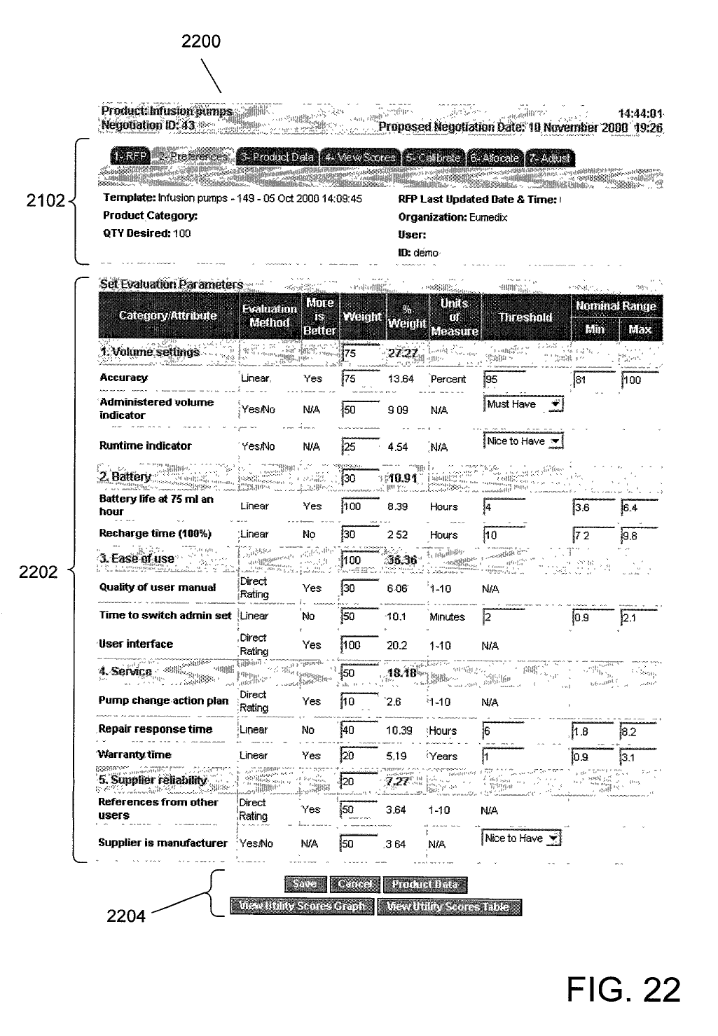

Once the product attributes have been specified, selecting the “Preferences” button 2118 accepts the input information and changes the screen to the screen of FIG. 22 which is also indicated and reachable by selecting the tab 2108 labeled “Preferences” in the header 2102. It should be noted for this example, that the screens are generally navigated in the order specified by the tabs 2108. However, it will be seen that, because the tabs are present on each screen, a person can move among the screens merely by selecting the appropriate tab 2108 at any time.

The preferences screen 2200 of FIG. 22 contains the header 2202 and much of the information carried over from the “Product” area 2116 of FIG. 21. Specifically, the “Category/Attribute”, “Evaluation Method” “More is Better” “Units of Measure” and “Threshold” information is common between FIG. 21 and FIG. 22 and contained within the “Set Evaluation Parameters” area 2202. Notably however, the “Threshold” information is contained in text entry or pull down boxes. This is because the information in those fields can still be changed on this screen 2200.

The “Weight” column is where the purchaser specifies the value for the particular criterion. When all the major attribute weights are supplied, the system calculates the corresponding “% Weight” using those values. For example, the 27.27 value specified for “Volume settings” is derived by dividing the 75 weight it received by the total for the major attributes (75+30+100+50+20=275).

Next, the purchaser specifies the weighting for each sub-criterion within each major category and the system calculates what portion of the major category % weight should apply to the particular sub-criterion. For example, under the “Volume settings” category, the weights of 75, 50 and 25 have been specified. Thus, the “Accuracy” sub-criterion represents 75/(75+50+25=150) or half of the 27.27% weighting (i.e. 13.64%).

The “Nominal Range” column reflects incorporation of the 10% “Nominal Factor into the linear range calculations. In the variant of this example, the Nominal Range can be changed by typing in a new value into the box. Thus, the 10% “rule” in this case represents a default rather than an immutable amount.

At the bottom of the screen, a group of buttons 2204 allows the purchaser to save the current information, cancel the changes or continue to the product data screen. Additionally, in this example, the system incorporates tools that allow the purchaser to view utility value information in graphical form or jump to the screen identified by the “View Scores” tab by selecting the “View Utility Scores Table” button.

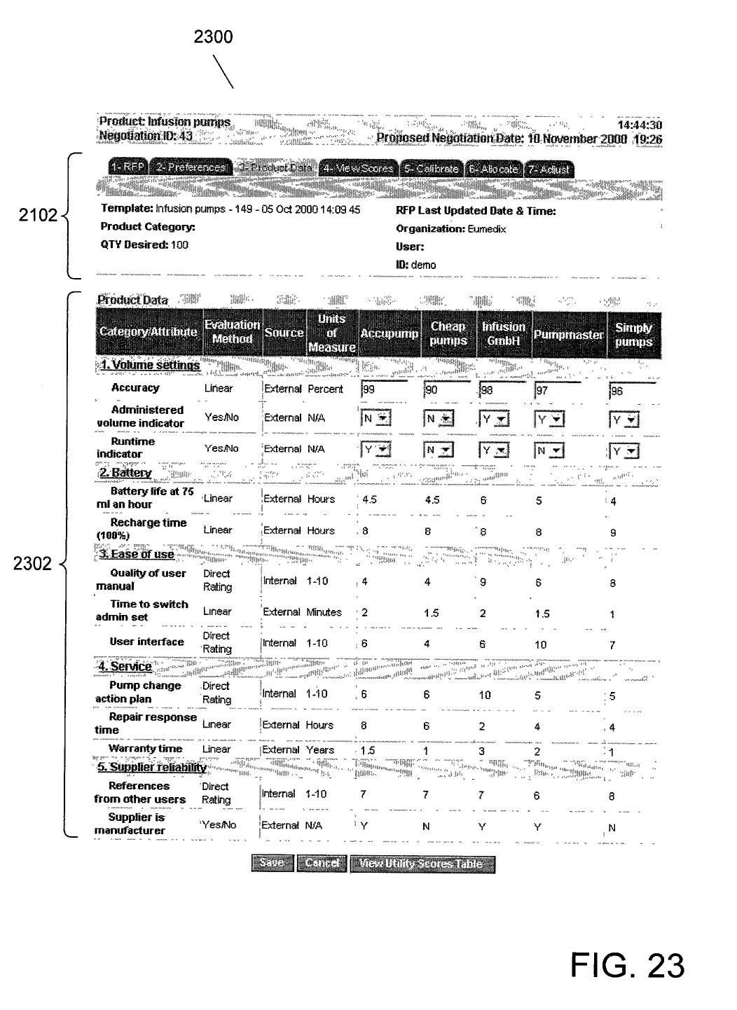

FIG. 23 is the next screen 2300 in the sequence. This screen 2300 also incorporates information carried over from the screens of FIGS. 21-22. In addition, the screen 2300 further includes data input by suppliers about their particular product offerings relative to the particular attributes and sub-criteria. As shown in FIG. 23, there are five potential suppliers 2302, 2304, 2306, 2308, 2310, respectively “Accupump”, “Cheap pumps”, “Infusion GmbH”, “Pumpmaster” and “Simply Pumps”. Note that, although the purchaser specified an accuracy threshold of 95%, the nominal range has caused the product from “Cheap pumps” to be included even though its accuracy is only 90%. This is because the nominal range spans accuracy values of 81 to 100% based upon the 10% nominal factor.

The product information for each sub-criterion, for each supplier's product, is listed under that supplier's name (or identifier, if the supplier is anonymous). It is worth noting, that if a particular supplier was offering two or more products, each would have its own correlation and, in this example, each would occupy its own individual column.

If the purchaser is satisfied with the particular suppliers, by clicking on the “View Utility Scores Table” button 2302, they move to the next screen. If however, the particular requirements specified by the purchaser resulted in less than a desired number of potential suppliers, for example zero, one, or in some cases even two or more suppliers, the purchaser could go back to one of the earlier screens to change their preferences/requirements such that additional suppliers will be included.

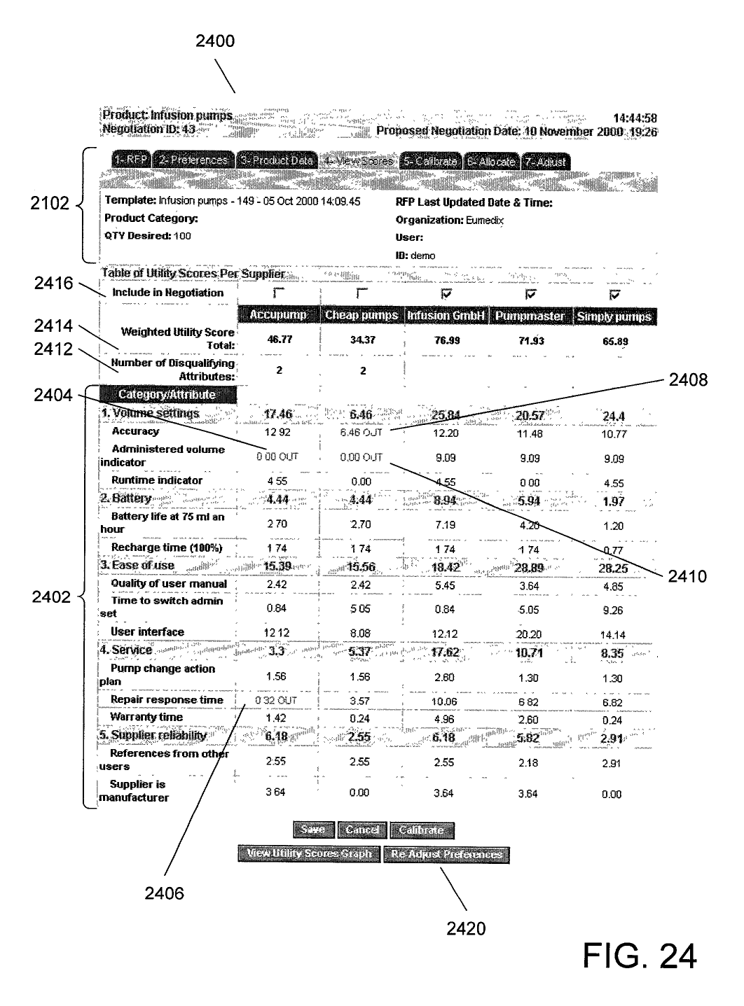

Assuming that everything is acceptable to this point, the purchaser continues on by clicking on the “View Utility Scores Table” button 2302 which brings up the screen 2400 of FIG. 24.

In addition to the material carried over from the screens of FIGS. 21-23, this screen 2400 contains the individual supplier utility values 2402 on an attribute and sub-criteria basis. In addition, those utility values 2404, 2406, 2408, 2410 that do not satisfy the purchaser specifications are indicated, in this case by the “OUT” designation.

Above the individual supplier utility values 2402, the total number of disqualifying attributes (i.e. those that fall outside the purchaser requirements) for each product, if any, are tabulated 2412. In addition, the overall weighted utility values are also shown 2414 on a product basis.

At this point, the purchaser has the option of selecting those suppliers to be included in the negotiation. Notably, in some cases, the purchaser may decide to include one or more suppliers who had one or more disqualifying attributes, for example, if the presence might provide pricing leverage. Alternatively, a supplier that otherwise satisfies all the criteria may be excluded, for example, because the purchaser has had some negative experience with that supplier or the particular product. Thus, the individual purchaser retains a great deal of control even if their needs will be aggregated with others for purposes of negotiation. Moreover, it is possible that, in some negotiations, different purchasers will select different suppliers. In those cases, from the purchaser perspective, each will see the negotiation as only involving the suppliers they have selected. From the supplier perspective, they will typically see the negotiation as involving the aggregate of those purchasers that have selected them.

Of course, although not typically desirable from a business standpoint, there is no impediment, from the standpoint of the description herein, of any purchaser also seeing non-selected supplier results and similarly, any supplier seeing allocations to non-selected suppliers or allocations by purchasers that did not select that particular supplier.

As noted above, if, for some reason, the purchaser is unhappy with the products shown, either because they have been too restrictive or not restrictive enough, the purchaser can fine tune their preferences by selecting the “Re-Adjust Preferences” button 2420 at the bottom of the screen or the “Preferences” tab in the header.

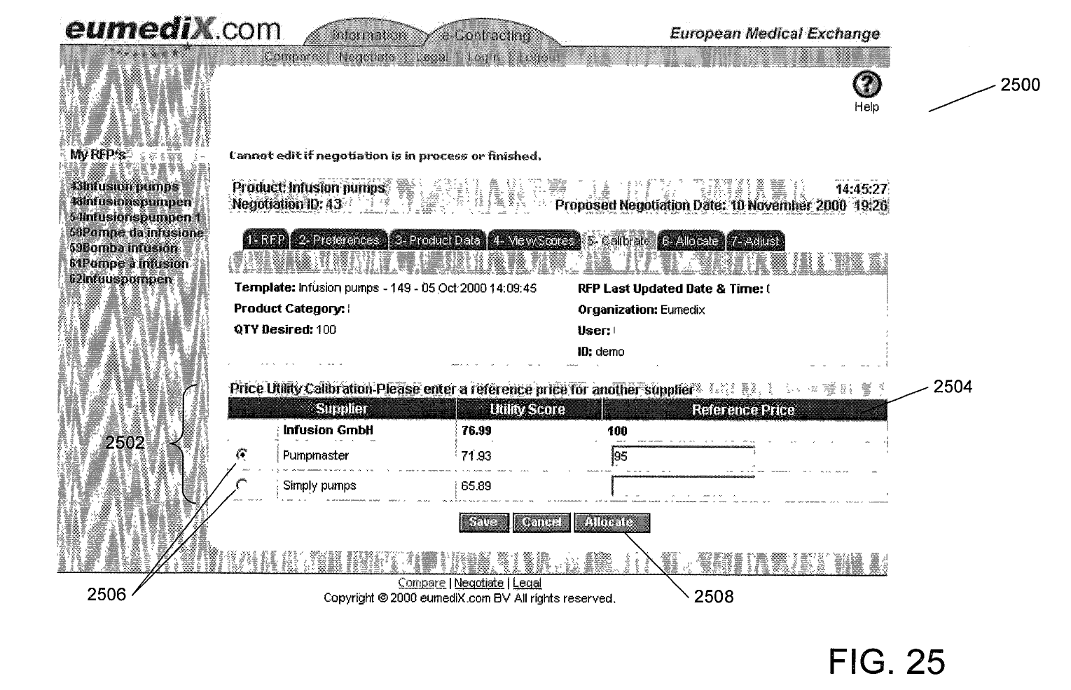

In the example, everything on this screen 2400 is acceptable to the purchaser and they have selected three of the five identified supplier products, those from Infusion GmbH, Pumpmaster and Simply pumps. The purchaser therefor selects the “Calibrate” button 2422 at the bottom of the screen 2400 and continues on to the screen 2500 of FIG. 25.

FIG. 25 is an example screen showing the overall utility value for each of the selected suppliers 2502. Since this negotiation involves products, the supplier having the highest overall utility value is assigned a reference price 2504 of 100. The purchaser is then given the option, in this example and variant, of selecting (using the radio buttons 2506) which of the other two suppliers they would like to provide the second reference price for based upon the hypothetical question, “if you were willing to pay 100 for the Infusion GmbH infusion pump, how much would you be willing to pay for the Pumpmaster infusion pump?” In this example, the purchaser enters a value of 95 for the Pumpmaster product and the system calculates a reference price for the Simply pumps product based upon one of the techniques described herein.

Once this is done, the “Allocate” button 2508 or tab in the header is selected to continue the process.

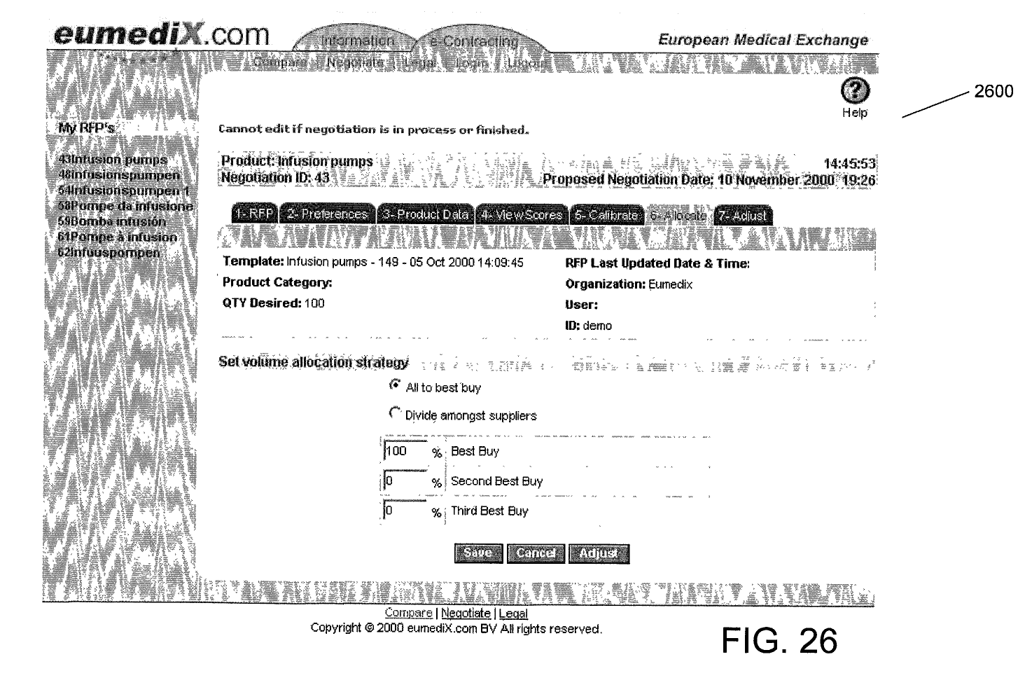

At this point, the purchaser is prompted to specify their allocation strategy on the screen 2600 of FIG. 26. The purchaser is provided the option of allocating all of their award volume to the supplier identified by the system as the Best Buy or dividing their volume, in this example on a percent basis, among the suppliers based upon their being the next best buy, the next thereafter, etc. In other variants, the allocation could have been specified in another manner, such as on a unit basis or left to manual allocation by the purchaser during the course of the negotiation using the Best Buy prompts as a guide.

At this point, the preliminaries for a negotiation is complete from the purchaser perspective.

In some cases, it may be desirable for a purchaser to additionally specify some premium they are willing to pay for a particular product or supplier or provide an adjustment factor relative to the offered product for some reason. For example, assume the negotiation is for defibrillators. One supplier may be offering units without any cables or monitor, whereas another may offer a complete kit containing cables and a monitor and a third may offer a unit with an integral monitor but patient cables must be purchased separately. Advantageously, the system as described herein can take these factors into account, for example, by allowing a purchaser to specify that they would pay a 50% premium for the second supplier's defibrillator relative to the first. Alternatively, a purchaser may, in some cases also be a supplier. In those cases, the purchaser may use a factor of less than one because they will be taking some portion of the product they purchase and resell it at a profit or package it differently. For example, a purchaser may buy injection packages containing one syringe and one alcohol wipe (as a unit) from one supplier and insulin from another supplier. The purchase may separate out the syringes from the unit and combine it with the insulin into kits made up of a weeks supply of syringes and insulin. They may, in turn sell the wipes separately or as part of some other offering.

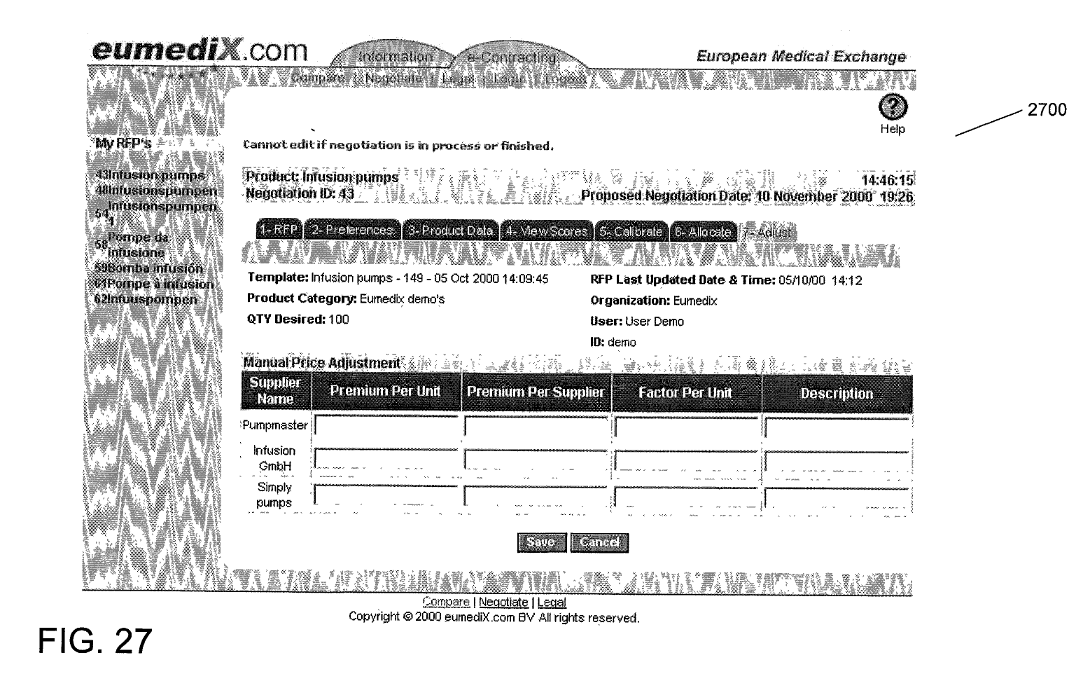

Assuming that the particular system includes this optional feature, a screen such as shown in FIG. 27 can be used to allow the purchaser to take such factors into account. As shown, the example screen allows an adjustment to be made for any supplier in terms of a positive or negative premium per unit, a positive or negative premium per supplier, or a factor per unit. Additionally, since it is likely that a purchaser may be involved in several negotiations at one time or that the purchaser may submit the information discussed above well in advance of the negotiation start date, the example system shown further includes a “Description” area where the purchaser can provide some explanation of the adjustment for later reference.

At some point, at or prior to the start of the negotiation, the suppliers submit their initial pricing and the negotiation proceeds as described herein.

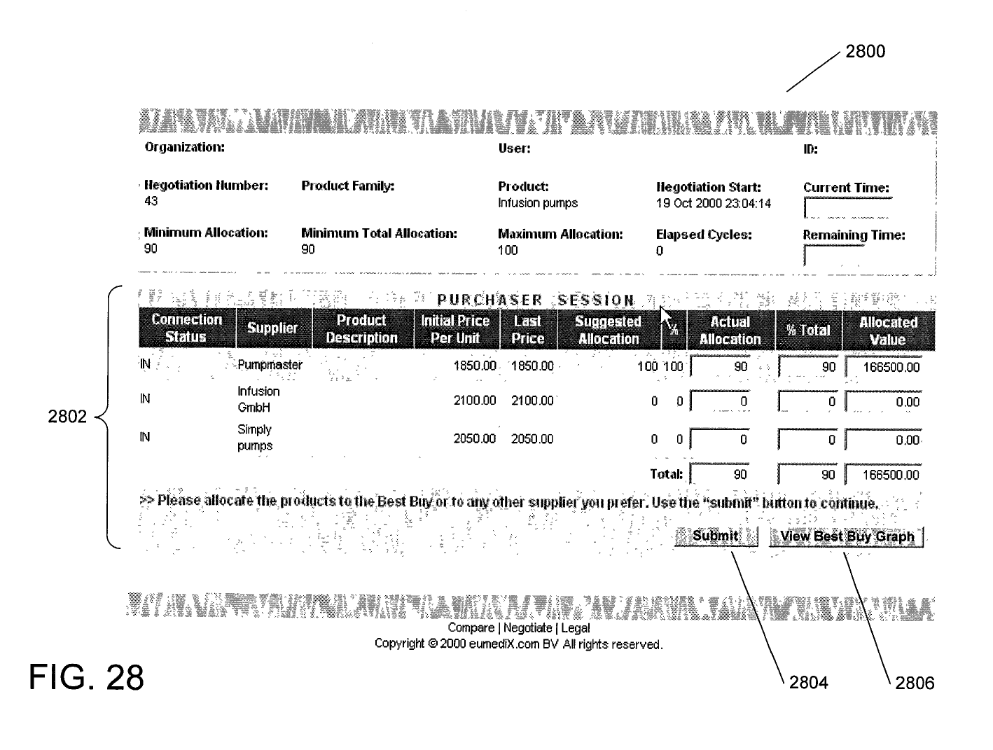

Once the negotiation begins, the purchaser accesses a negotiation screen 2800 of FIG. 28. Certain information from FIGS. 21-27 will be displayed, for example, the Organization, User, User ID, Negotiation Number, Product Family, Product, Negotiation Start Date, Negotiation Start Time, Current Time, Minimum Allocation, Minimum Total Allocation, Maximum Allocation, Number of Elapsed Cycles, and the Remaining Time for the negotiation.

In a “Purchaser Session” area 2802, the purchaser, for this example, also sees displayed a “Connection Status” that indicates if the particular supplier is logged in at that time, an identifier for the supplier (in this example, the supplier name), a product description, if applicable, the initial price per unit specified by each supplier, the last price each supplier entered, a suggested allocation based upon the allocation strategy specified by the purchaser, the allocation in terms of percent, The actual allocation in terms of units, the percentage of the total represented by the actual allocation, and the allocated value which represents the volume allocated times the last price.

As the prices change, the purchase can modify their allocation by entering a change, in the example of FIG. 28 in any space beneath the columns labeled “Actual Allocation”, “% Total” or “Allocated Value”, the last being useful if there is some restriction on a purchaser awarding more than a specified monetary value to any particular supplier(s). Once a change has been made, clicking the “Submit” button 2804 submits the change.

Thereafter, the negotiation proceeds in alternating cycles as described above.

It should be understood that the above description is only representative of illustrative embodiments. For the convenience of the reader, the above description has focused on a representative sample of all possible embodiments, a sample that teaches the principles of the invention. The description has not attempted to exhaustively enumerate all possible variations. That alternate embodiments may not have been presented for a specific portion of the invention, or that further undescribed alternate embodiments or other combinations of described portions may be available, is not to be considered a disclaimer of those alternate embodiments. It can be appreciated that many of those undescribed embodiments are within the literal scope of the following claims, and others are equivalent.

What is claimed is:

1. A negotiation method involving multiple purchasers comprising:
analyzing utility information supplied by at least one of the multiple purchasers relative to at least two semi-fungible products;
providing supplier specified prices to the multiple purchasers; and
identifying, to at least one of the multiple purchasers, which of the supplier specified prices represents a best value.

2. The method of claim 1 further comprising:
receiving a purchaser supplied benchmark value.

3. The method of claim 1 further comprising:
analyzing information supplied by at least one supplier relative to a result of the analyzing the information supplied by at least one of the multiple purchasers.

4. The method of claim 1 further comprising:
aggregating volumes, specified by at least two of the multiple purchasers, allocated to at least one of the at least two semi-fungible products.

5. An on-line method comprising:
a) calculating, using a negotiation server, an overall utility-price function for at least two semi-fungible products, from product related utility assignments and pricing positions;
b) calculating a value pricing for the at least two semi-fungible products based upon a benchmark price provided for one of the at least two semi-fungible commodity items;
c) receiving supplier prices for each of the at least two semi-fungible products; and
d) indicating a best buy based upon the value pricing.

6. The on-line method of claim 5 further comprising:
receiving a first allocation to at least one of the at least two semi-fungible products.

7. The on line method of claim 5 further comprising:
receiving a price change for one of the at least two semi-fungible products; and
receiving an allocation modification following the price change.

8. An on-line multi-purchaser, multi-supplier negotiation method comprising:
receiving price commitments from at least two suppliers to supply up to a specified quantity of semi-fungible products within a product category;
identifying at least some of the price commitments to a first purchaser having a first requirement;
calculating trade-off value prices relative to the first purchaser;
receiving an allocation of at least some of the first requirement to at least one of the suppliers;
identifying the allocation to the suppliers;
recommending a best buy pricing to at least one of the suppliers; and
receiving a price modification from at least one of the suppliers following the recommendation.

9. The method of claim 8 further comprising:
communicating a suggested award allocation.

10. The method of claim 8 further comprising:
prompting for utility information.

11. The method of claim 8 further comprising:
graphically displaying a price vs. utility graph.

12. The method of claim 8 further comprising:
prompting for a utility value for each of the semi-fungible products.

13. The method of claim 8 further comprising:
prompting for a pricing position for each of the semi-fungible products.

14. The method of claim 13 further comprising:
prompting for utility values for each of the semi-fungible products.

15. The method of claim 14 further comprising:
normalizing the utility values.

16. The method of claim 13 further comprising:
normalizing the pricing positions.

17. A method of computerized aggregation for group purchasing involving at least three entities comprising:
providing a best buy indication to at least one of the at least three entities, based upon an analysis of benchmark information, for at least one semi-fungible product within a category, the at least one semi-fungible product having been offered by a first entity selected from among at least three entities;
receiving, from the at least one entity, an allocation of a portion of a total needs to at least one of the first entity or a second entity, the second entity also being selected from among the at least three entities; and
aggregating the allocation with a needs allocation, from at least one other entity.

18. The method of claim 17 further comprising:
incorporating the best buy indication into an entity viewable screen.

19. The method of claim 17 further comprising:
graphically indicating an offering parameter relative to a utility function graph.

20. The method of claim 17 further comprising:
prompting for utility values for the at least one semi-fungible product.

21. The method of claim 17 further comprising:
prompting for pricing values for the at least one semi-fungible product.

22. A negotiation method comprising:
submitting a binding bid of a product at a specified price;
receiving an allocation of an award for the semi-fungible product;
receiving an identification of a calculated recommendation based upon information derived from an entity; and
reducing the specified price by an amount in response to the recommendation.

23. The negotiation method of claim 22 further comprising:
receiving an indication reflecting allocations to a competing provider.

24. The negotiation method of claim 22 further comprising:
receiving an elapsed negotiation time indication.

25. The negotiation method of claim 22 further comprising:
receiving a bid differential identifier.

26. An on-line negotiation method comprising:
engaging at least two purchasers and at least two providers in a negotiation session,
receiving, from a first of the at least two providers, a first bid of a first offering from a semi-fungible category at a first amount;
receiving, from a second of the at least two providers, a second bid of a second offering from the semi-fungible category at a second amount;
identifying a best value for a purchaser based upon a criterion specified by the purchaser and the first and second amounts;
allowing at least one of the purchasers to individually specify, via an on-line interface, how they will allocate an award to at least one of the at least two providers; and
allowing at least one of the purchasers to modify their allocation following an amount modification by either of the first or second providers.

27. The method of claim 26 further comprising:
prompting at least one of the purchasers for utility information.

28. The method of claim 26 further comprising:
graphically displaying a price vs. utility graph.

29. The method of claim 26 further comprising:
calculating a trade-off value for each of the first and second offerings.

30. The method of claim 26 further comprising:
calculating a provider recommendation.

31. The method of claim 30 further comprising:
prompting at least one purchaser for utility values for each of the offerings.

32. The method of claim 31 further comprising:
normalizing the utility values.

33. The method of claim 26 further comprising:
calculating a utility score based upon information supplied by the purchaser.

34. A system for use in an on-line negotiation involving multiple offerors and multiple requirers, the system comprising:
a program stored on a computer readable medium which when executed by a processor:
a) receives, from a first of at least two offerors, a first bid of a first semi-fungible offering at a first amount;
b) receives, from a second of the at least two offerors, a second bid of a second semi-fungible offering at a second amount;
c) determines which of the first or second bids is a best buy for at least one requirer using a decision making tool; and
d) allows the at least one requirer to specify an allocation to at least one of the at least two offerors during a specified time period.

35. A system comprising:
means for calculating a best value indication using parameters received from a purchaser;
first graphical means for displaying to the purchaser a current state of a negotiation including the best value indication;
second graphical means for displaying a recommended pricing change to a supplier; and
means for receiving a supplier pricing change.

36. The system of claim 35 further comprising:
means for sequencing between purchasers and suppliers at intervals.

37. The system of claims 35 further comprising:
means for determining a price utility function using at least one purchaser specified parameter.

38. A method for computer assisted purchasing comprising:
a) receiving an allocation of a purchaser volume to at least one of at least two supplier offered semi-fungible commodity items;
b) aggregating the allocation with a volume allocation of at least one other purchaser;
c) calculating a purchaser specific trade-off value for at least one of the at least two supplier offered semi-fungible commodity items; and
d) providing an identification of a commodity item which best satisfies the purchaser specific trade-off value criterion.

39. The method of claim 38 further comprising:
adjusting a price utility indicator following a repricing for a semi-fungible commodity item.

40. A method of operating a computer system comprising:
aggregating purchaser allocations of volumes to semi-fungible commodity items;
following a price change, recalculating a trade-off value; and
prompting for a modification based upon the trade-off value.

41. The method of claim 40 wherein the prompting includes:
suggesting best buy.

42. The method of claim 40 wherein the prompting includes:
suggesting a revised price based upon a maximization calculation.

43. The method of claim 40 further comprising:
displaying a group of semi-fungible commodity items falling within a nominal range.

44. The method of claim 40 further comprising:
calculating a nominal range for a product attribute based upon a purchaser specified value.

45. A negotiation method comprising:
allowing an entity to allocate needs to at least one of at least two tendered semi-fungible category components, all of the at least two tendered components being either a product item, a service or a right, and each having an associated value specified by its respective tenderor and an index representing a utility to the entity; and
allowing a tenderor to modify the associated value following an allocation by the entity.

46. The negotiation method of claim 45 wherein the entity is one of at least two entities, the method further comprising:
allowing another of the at least two entities to allocate a needs award to at least one of at least two tendered semi-fungible category components.

47. The negotiation method of claim 46 further comprising:
providing for utility adjusted valuing.

48. The negotiation method of claim 45 further comprising:
providing for utility adjusted valuing.

49. The negotiation method of claim 45 further comprising:
providing optimization prompting.

50. The negotiation method of claim 45 further comprising:
providing value for money prompting.

51. The negotiation method of claim 45 further comprising:
providing maximization prompting.
